(19) United States
(12) Patent Application Publication
(10) Pub. No.: US 2017/0345033 A1
(43) Pub. Date: Nov. 30, 2017

(54) Apparatus and Method for Customizing Products on a Regional Basis

(71) Applicant: Wal-Mart Stores, Inc., Bentonville, AR (US)

(72) Inventors: Bruce W. Wilkinson, Rogers, AR (US); Matthew A. Jones, Bentonville, AR (US); Aaron J. Vasgaard, Rogers, AR (US); Robert J. Taylor, Rogers, AR (US); Balaraman Kirthigaivasan, Bentonville, AR (US); Gregory A. Hicks, Rogers, AR (US); Nathan G. Jones, Bentonville, AR (US); Todd D. Mattingly, Bentonville, AR (US)

(21) Appl. No.: 15/606,602

(22) Filed: May 26, 2017

Related U.S. Application Data
(60) Provisional application No. 62/341,993, filed on May 26, 2016.
(60) Provisional application No. 62/471,830, filed on Mar. 15, 2017.
(60) Provisional application No. 62/358,748, filed on Jul. 6, 2016.
(60) Provisional application No. 62/510,322, filed on May 24, 2017.
(60) Provisional application No. 62/348,444, filed on Jun. 10, 2016.
(60) Provisional application No. 62/436,842, filed on Dec. 20, 2016.
(60) Provisional application No. 62/485,045, filed on Apr. 13, 2017.

(51) Int. Cl. G06Q 30/02; G06Q 10/06

(52) U.S. Cl. CPC G06Q 30/0205; G06Q 10/0637; G06Q 30/0201

(57) ABSTRACT

Various partialities (including but not limited to partialities based on values, aspirations, preferences, and/or affinities) for individual persons are represented as corresponding vectors. The length and/or the angle of the vector represents the magnitude of the strength of the individual's belief in the good that comes from that imposed order. Vectors can also be specified to characterize corresponding products and/or services. These vectors for persons and products/services can be leveraged in any of a wide variety of ways. By one approach a particular partiality vector is used to identify a particular customization for a geographic region (i.e., a particular customization to employ with a base product).

### RELATED APPLICATION(S)

This application claims the benefit of U.S. Provisional Application No. 62/341,993, filed May 26, 2016, U.S. Provisional Application No. 62/358,748, filed Jul. 6, 2016, U.S. Provisional Application No. 62/348,444, filed Jun. 10, 2016, U.S. Provisional Application No. 62/436,842, filed Dec. 20, 2016, U.S. Provisional Application No. 62/471,830, filed Mar. 15, 2017, U.S. Provisional Application No. 62/485,045, filed Apr. 13, 2017, and U.S. Provisional Application No. 62/510,322, filed May 24, 2017, all of which are incorporated herein by reference in their entirety.

### TECHNICAL FIELD

These teachings relate generally to providing products and services to individuals and more particularly to providing customized products including regionally-customized products.

### BACKGROUND

Various shopping paradigms are known in the art. One approach of long-standing use essentially comprises displaying a variety of different goods at a shared physical location and allowing consumers to view/experience those offerings as they wish to thereby make their purchasing selections. This model is being increasingly challenged due at least in part to the logistical and temporal inefficiencies that accompany this approach and also because this approach does not assure that a product best suited to a particular consumer will in fact be available for that consumer to purchase at the time of their visit.

Increasing efforts are being made to present a given consumer with one or more purchasing options that are selected based upon some preference of the consumer. When done properly, this approach can help to avoid presenting the consumer with things that they might not wish to consider. That said, existing preference-based approaches nevertheless leave much to be desired. Information regarding preferences, for example, may tend to be very product specific and accordingly may have little value apart from use with a very specific product or product category. As a result, while helpful, a preferences-based approach is inherently very limited in scope and offers only a very weak platform by which to assess a wide variety of product and service categories.

### BRIEF DESCRIPTION OF THE DRAWINGS

The above needs are at least partially met through provision of the vector-based characterizations of products described in the following detailed description, particularly when studied in conjunction with the drawings, wherein:

FIG. 1 comprises a flow diagram as configured in accordance with various embodiments of these teachings;

FIG. 2 comprises a flow diagram as configured in accordance with various embodiments of these teachings;

FIG. 3 comprises a graphic representation as configured in accordance with various embodiments of these teachings;

FIG. 4 comprises a graph as configured in accordance with various embodiments of these teachings;

FIG. 5 comprises a flow diagram as configured in accordance with various embodiments of these teachings;

FIG. 6 comprises a graphic representation as configured in accordance with various embodiments of these teachings;

FIG. 7 comprises a graphic representation as configured in accordance with various embodiments of these teachings;

FIG. 8 comprises a graphic representation as configured in accordance with various embodiments of these teachings;

FIG. 9 comprises a flow diagram as configured in accordance with various embodiments of these teachings;

FIG. 10 comprises a flow diagram as configured in accordance with various embodiments of these teachings;

FIG. 11 comprises a graphic representation as configured in accordance with various embodiments of these teachings;

FIG. 12 comprises a graphic representation as configured in accordance with various embodiments of these teachings;

FIG. 13 comprises a block diagram as configured in accordance with various embodiments of these teachings;

FIG. 14 comprises a flow diagram as configured in accordance with various embodiments of these teachings;

FIG. 15 comprises a graph as configured in accordance with various embodiments of these teachings;

FIG. 16 comprises a flow diagram as configured in accordance with various embodiments of these teachings;

FIG. 17 comprises a block diagram as configured in accordance with various embodiments of these teachings;

FIG. 18 comprises a block diagram as configured in accordance with various embodiments of these teachings;

FIG. 19 comprises a flow diagram as configured in accordance with various embodiments of these teachings;

FIG. 20 comprises a schematic representation as configured in accordance with various embodiments of these teachings;

FIG. 21 comprises a block diagram as configured in accordance with various embodiments of these teachings;

FIG. 22 comprises a flow diagram as configured in accordance with various embodiments of these teachings;

FIG. 23 comprises a flow diagram as configured in accordance with various embodiments of these teachings;

FIG. 24 comprises a block diagram as configured in accordance with various embodiments of these teachings;

FIG. 25 comprises a flow diagram as configured in accordance with various embodiments of these teachings; and

FIG. 26 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, by one approach many of these various embodiments provide a plurality of base products (for example, at each of a plurality of retail shopping facilities that are, in turn, each located in a different geographic region). For each of a corresponding plurality of different geographic regions, these teachings then provide for accessing partiality vectors for people associated with those regions. These teachings then provide for using those partiality vectors to identify a particular partiality vector that is representative of people (i.e., a plurality of people) who are associated with the geographic region (for example, they reside within the geographic region and/or are employed on a regular basis within the geographic region). That particular partiality vector is used to identify a particular customization for the geographic region (i.e., a particular customization to employ with the aforementioned base product). That particular customization is then used to particularly customize the base products such that at least some of the base products offered within a given geographic region are customized in a way that corresponds to the particular partiality vector that is representative of people associated with that geographic region.

By one approach the aforementioned partiality vector represents at least one of a person's values, preferences, and affinities.

These teachings are highly flexible in practice. As one example in these regards, the aforementioned particular customization can comprise adding additional product content to the base product to form a composite product. When the relevant partiality vector pertains, for example, to a partiality for locally-grown items, the base product can comprise a snack pack having one or more items that are not suitable for local sourcing and the customization can comprise adding at least one locally-grown edible item.

By one approach, these teachings can include calculating or otherwise determining a number of people associated with the geographic region that corresponds to a particular representative partiality vector. That ascertained number can then serve to help determine how many of the base products to customize to serve that geographic region.

So configured, customized products can be readily provided for display and sale at retail shopping facilities that have an increased likelihood of meeting agreeably with the partialities of persons likely to shop at such a retail shopping facility on a region-by-region basis. These teachings facilitate a powerful synergy that harnesses economies of scale associated with mass production with the value of locally-based customization.

In some embodiments, a system for providing custom manufacturing comprises a communication device configured to communicate with a plurality of user devices and a plurality of manufacturer systems over a network. a customer database storing customer profiles associated with a plurality of customers, a manufacturer database storing manufacturer characteristics associated with a plurality of manufacturers, and a control circuit coupled to the communication device, the customer database, and the manufacturer database, the control circuit being configured to: provide a custom manufacturing user interface to the plurality of user devices, receive a custom manufacturing request from a user via the custom manufacturing user interface, retrieve a customer profile associated with the user from the customer database, determine alignments between the customer profile and the manufacturer characteristics associated with the plurality of manufacturers stored in the manufacturer database, select matching manufacturers from the plurality of manufacturers based on the alignments, forward the custom manufacturing request to manufacturer systems associated with the matching manufacturers for bidding, receive bids for the custom manufacturing request from the manufacturer systems, and fulfill the custom manufacturing request with a bid associated with a manufacturer selected from among the bids.

Generally speaking, many of these embodiments provide for a memory having information stored therein that includes partiality information for each of a plurality of persons in the form of a plurality of partiality vectors for each of the persons wherein each partiality vector has at least one of a magnitude and an angle that corresponds to a magnitude of the person's belief in an amount of good that comes from an order associated with that partiality. This memory can also contain vectorized characterizations for each of a plurality of products, wherein each of the vectorized characterizations includes a measure regarding an extent to which a corresponding one of the products accords with a corresponding one of the plurality of partiality vectors.

Rules can then be provided that use the aforementioned information in support of a wide variety of activities and results. Although the described vector-based approaches bear little resemblance (if any) (conceptually or in practice) to prior approaches to understanding and/or metricizing a given person's product/service requirements, these approaches yield numerous benefits including, at least in some cases, reduced memory requirements, an ability to accommodate (both initially and dynamically over time) an essentially endless number and variety of partialities and/or product attributes, and processing/comparison capabilities that greatly ease computational resource requirements and/or greatly reduced time-to-solution results.

So configured, these teachings can constitute, for example, a method for automatically correlating a particular product with a particular person by using a control circuit to obtain a set of rules that define the particular product from amongst a plurality of candidate products for the particular person as a function of vectorized representations of partialities for the particular person and vectorized characterizations for the candidate products. This control circuit can also obtain partiality information for the particular person in the form of a plurality of partiality vectors that each have at least one of a magnitude and an angle that corresponds to a magnitude of the particular person's belief in an amount of good that comes from an order associated with that partiality and vectorized characterizations for each of the candidate products, wherein each of the vectorized characterizations indicates a measure regarding an extent to which a corresponding one of the candidate products accords with a corresponding one of the plurality of partiality vectors. The control circuit can then generate an output comprising identification of the particular product by evaluating the partiality vectors and the vectorized characterizations against the set of rules.

The aforementioned set of rules can include, for example, comparing at least some of the partiality vectors for the particular person to each of the vectorized characterizations for each of the candidate products using vector dot product calculations. By another approach, in lieu of the foregoing or in combination therewith, the aforementioned set of rules can include using the partiality vectors and the vectorized characterizations to define a plurality of solutions that collectively form a multi-dimensional surface and selecting the particular product from the multi-dimensional surface. In such a case the set of rules can further include accessing other information (such as objective information) for the particular person comprising information other than partiality vectors and using the other information to constrain a selection area on the multi-dimensional surface from which the particular product can be selected.

People tend to be partial to ordering various aspects of their lives, which is to say, people are partial to having things well arranged per their own personal view of how things should be. As a result, anything that contributes to the proper ordering of things regarding which a person has partialities represents value to that person. Quite literally, improving order reduces entropy for the corresponding person (i.e., a reduction in the measure of disorder present in that particular aspect of that person's life) and that improvement in order/reduction in disorder is typically viewed with favor by the affected person.

Generally speaking a value proposition must be coherent (logically sound) and have “force.” Here, force takes the form of an imperative. When the parties to the imperative have a reputation of being trustworthy and the value proposition is perceived to yield a good outcome, then the imperative becomes anchored in the center of a belief that “this is something that I must do because the results will be good for me.” With the imperative so anchored, the corresponding material space can be viewed as conforming to the order specified in the proposition that will result in the good outcome.

Pursuant to these teachings a belief in the good that comes from imposing a certain order takes the form of a value proposition. It is a set of coherent logical propositions by a trusted source that, when taken together, coalesce to form an imperative that a person has a personal obligation to order their lives because it will return a good outcome which improves their quality of life. This imperative is a value force that exerts the physical force (effort) to impose the desired order. The inertial effects come from the strength of the belief. The strength of the belief comes from the force of the value argument (proposition). And the force of the value proposition is a function of the perceived good and trust in the source that convinced the person's belief system to order material space accordingly. A belief remains constant until acted upon by a new force of a trusted value argument. This is at least a significant reason why the routine in people's lives remains relatively constant.

Newton's three laws of motion have a very strong bearing on the present teachings. Stated summarily, Newton's first law holds that an object either remains at rest or continues to move at a constant velocity unless acted upon by a force, the second law holds that the vector sum of the forces F on an object equal the mass m of that object multiplied by the acceleration a of the object (i.e., F=ma), and the third law holds that when one body exerts a force on a second body, the second body simultaneously exerts a force equal in magnitude and opposite in direction on the first body.

Relevant to both the present teachings and Newton's first law, beliefs can be viewed as having inertia. In particular, once a person believes that a particular order is good, they tend to persist in maintaining that belief and resist moving away from that belief. The stronger that belief the more force an argument and/or fact will need to move that person away from that belief to a new belief.

Relevant to both the present teachings and Newton's second law, the “force” of a coherent argument can be viewed as equaling the “mass” which is the perceived Newtonian effort to impose the order that achieves the aforementioned belief in the good which an imposed order brings multiplied by the change in the belief of the good which comes from the imposition of that order. Consider that when a change in the value of a particular order is observed then there must have been a compelling value claim influencing that change. There is a proportionality in that the greater the change the stronger the value argument. If a person values a particular activity and is very diligent to do that activity even when facing great opposition, we say they are dedicated, passionate, and so forth. If they stop doing the activity, it begs the question, what made them stop? The answer to that question needs to carry enough force to account for the change.

And relevant to both the present teachings and Newton's third law, for every effort to impose good order there is an equal and opposite good reaction.

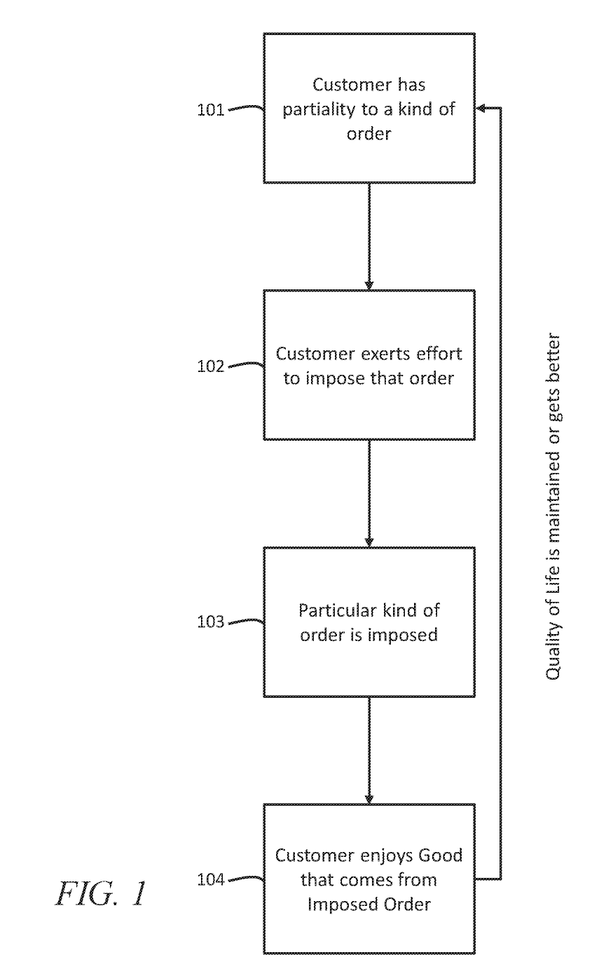

FIG. 1 provides a simple illustrative example in these regards. At block 101 it is understood that a particular person has a partiality (to a greater or lesser extent) to a particular kind of order. At block 102 that person willingly exerts effort to impose that order to thereby, at block 103, achieve an arrangement to which they are partial. And at block 104, this person appreciates the “good” that comes from successfully imposing the order to which they are partial, in effect establishing a positive feedback loop.

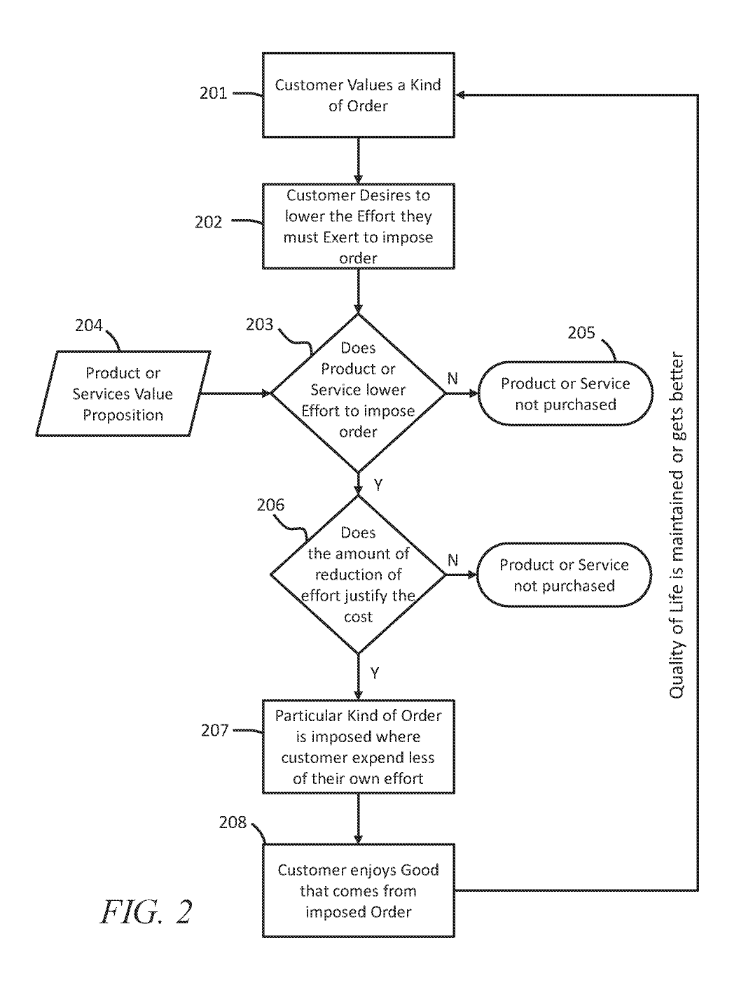

Understanding these partialities to particular kinds of order can be helpful to understanding how receptive a particular person may be to purchasing a given product or service. FIG. 2 provides a simple illustrative example in these regards. At block 201 it is understood that a particular person values a particular kind of order. At block 202 it is understood (or at least presumed) that this person wishes to lower the effort (or is at least receptive to lowering the effort) that they must personally exert to impose that order. At decision block 203 (and with access to information 204 regarding relevant products and or services) a determination can be made whether a particular product or service lowers the effort required by this person to impose the desired order. When such is not the case, it can be concluded that the person will not likely purchase such a product/service 205 (presuming better choices are available).

When the product or service does lower the effort required to impose the desired order, however, at block 206 a determination can be made as to whether the amount of the reduction of effort justifies the cost of purchasing and/or using the proffered product/service. If the cost does not justify the reduction of effort, it can again be concluded that the person will not likely purchase such a product/service 205. When the reduction of effort does justify the cost, however, this person may be presumed to want to purchase the product/service and thereby achieve the desired order (or at least an improvement with respect to that order) with less expenditure of their own personal effort (block 207) and thereby achieve, at block 208, corresponding enjoyment or appreciation of that result.

To facilitate such an analysis, the applicant has determined that factors pertaining to a person's partialities can be quantified and otherwise represented as corresponding vectors (where “vector” will be understood to refer to a geometric object/quantity having both an angle and a length/magnitude). These teachings will accommodate a variety of differing bases for such partialities including, for example, a person's values, affinities, aspirations, and preferences.

A value is a person's principle or standard of behavior, their judgment of what is important in life. A person's values represent their ethics, moral code, or morals and not a mere unprincipled liking or disliking of something. A person's value might be a belief in kind treatment of animals, a belief in cleanliness, a belief in the importance of personal care, and so forth.

An affinity is an attraction (or even a feeling of kinship) to a particular thing or activity. Examples including such a feeling towards a participatory sport such as golf or a spectator sport (including perhaps especially a particular team such as a particular professional or college football team), a hobby (such as quilting, model railroading, and so forth), one or more components of popular culture (such as a particular movie or television series, a genre of music or a particular musical performance group, or a given celebrity, for example), and so forth.

“Aspirations” refer to longer-range goals that require months or even years to reasonably achieve. As used herein “aspirations” does not include mere short term goals (such as making a particular meal tonight or driving to the store and back without a vehicular incident). The aspired-to goals, in turn, are goals pertaining to a marked elevation in one's core competencies (such as an aspiration to master a particular game such as chess, to achieve a particular articulated and recognized level of martial arts proficiency, or to attain a particular articulated and recognized level of cooking proficiency), professional status (such as an aspiration to receive a particular advanced education degree, to pass a professional examination such as a state Bar examination of a Certified Public Accountants examination, or to become Board certified in a particular area of medical practice), or life experience milestone (such as an aspiration to climb Mount Everest, to visit every state capital, or to attend a game at every major league baseball park in the United States). It will further be understood that the goal(s) of an aspiration is not something that can likely merely simply happen of its own accord; achieving an aspiration requires an intelligent effort to order one's life in a way that increases the likelihood of actually achieving the corresponding goal or goals to which that person aspires. One aspires to one day run their own business as versus, for example, merely hoping to one day win the state lottery.

A preference is a greater liking for one alternative over another or others. A person can prefer, for example, that their steak is cooked “medium” rather than other alternatives such as “rare” or “well done” or a person can prefer to play golf in the morning rather than in the afternoon or evening. Preferences can and do come into play when a given person makes purchasing decisions at a retail shopping facility. Preferences in these regards can take the form of a preference for a particular brand over other available brands or a preference for economy-sized packaging as versus, say, individual serving-sized packaging.

Values, affinities, aspirations, and preferences are not necessarily wholly unrelated. It is possible for a person's values, affinities, or aspirations to influence or even dictate their preferences in specific regards. For example, a person's moral code that values non-exploitive treatment of animals may lead them to prefer foods that include no animal-based ingredients and hence to prefer fruits and vegetables over beef and chicken offerings. As another example, a person's affinity for a particular musical group may lead them to prefer clothing that directly or indirectly references or otherwise represents their affinity for that group. As yet another example, a person's aspirations to become a Certified Public Accountant may lead them to prefer business-related media content.

While a value, affinity, or aspiration may give rise to or otherwise influence one or more corresponding preferences, however, is not to say that these things are all one and the same; they are not. For example, a preference may represent either a principled or an unprincipled liking for one thing over another, while a value is the principle itself. Accordingly, as used herein it will be understood that a partiality can include, in context, any one or more of a value-based, affinity-based, aspiration-based, and/or preference-based partiality unless one or more such features is specifically excluded per the needs of a given application setting.

Information regarding a given person's partialities can be acquired using any one or more of a variety of information-gathering and/or analytical approaches. By one simple approach, a person may voluntarily disclose information regarding their partialities (for example, in response to an online questionnaire or survey or as part of their social media presence). By another approach, the purchasing history for a given person can be analyzed to intuit the partialities that led to at least some of those purchases. By yet another approach demographic information regarding a particular person can serve as yet another source that sheds light on their partialities. Other ways that people reveal how they order their lives include but are not limited to: (1) their social networking profiles and behaviors (such as the things they “like” via Facebook, the images they post via Pinterest, informal and formal comments they initiate or otherwise provide in response to third-party postings including statements regarding their own personal long-term goals, the persons/topics they follow via Twitter, the photographs they publish via Picasso, and so forth); (2) their Internet surfing history; (3) their on-line or otherwise-published affinity-based memberships; (4) real-time (or delayed) information (such as steps walked, calories burned, geographic location, activities experienced, and so forth) from any of a variety of personal sensors (such as smart phones, tablet/pad-styled computers, fitness wearables, Global Positioning System devices, and so forth) and the so-called Internet of Things (such as smart refrigerators and pantries, entertainment and information platforms, exercise and sporting equipment, and so forth); (5) instructions, selections, and other inputs (including inputs that occur within augmented-reality user environments) made by a person via any of a variety of interactive interfaces (such as keyboards and cursor control devices, voice recognition, gesture-based controls, and eye tracking-based controls), and so forth.

The present teachings employ a vector-based approach to facilitate characterizing, representing, understanding, and leveraging such partialities to thereby identify products (and/or services) that will, for a particular corresponding consumer, provide for an improved or at least a favorable corresponding ordering for that consumer. Vectors are directed quantities that each have both a magnitude and a direction. Per the applicant's approach these vectors have a real, as versus a metaphorical, meaning in the sense of Newtonian physics. Generally speaking, each vector represents order imposed upon material space-time by a particular partiality.

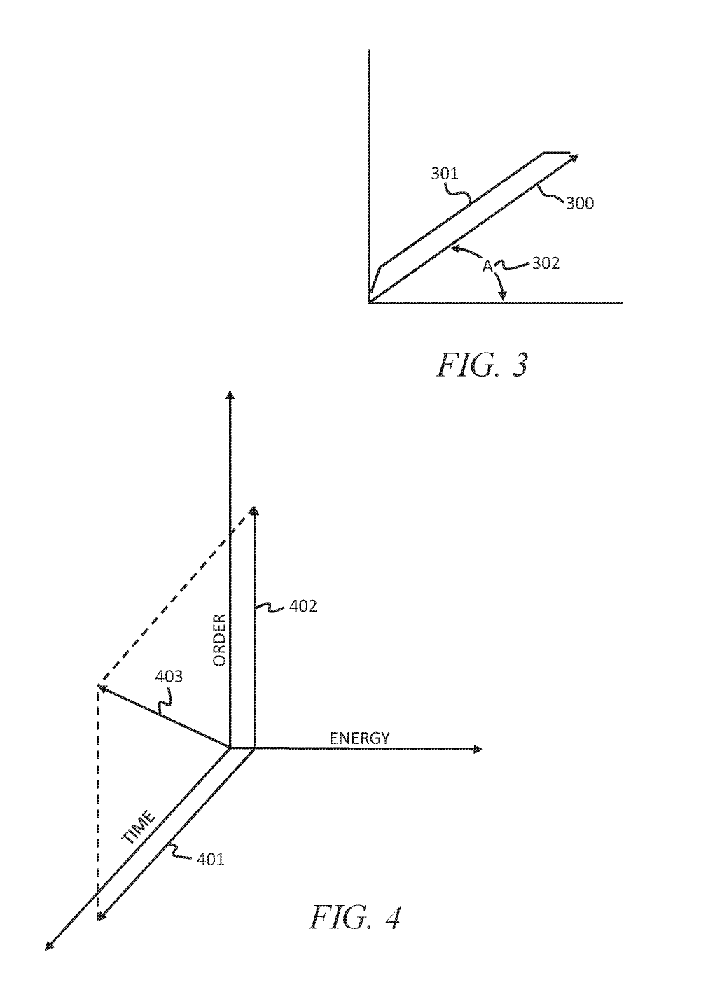

FIG. 3 provides some illustrative examples in these regards. By one approach the vector 300 has a corresponding magnitude 301 (i.e., length) that represents the magnitude of the strength of the belief in the good that comes from that imposed order (which belief, in turn, can be a function, relatively speaking, of the extent to which the order for this particular partiality is enabled and/or achieved). In this case, the greater the magnitude 301, the greater the strength of that belief and vice versa. Per another example, the vector 300 has a corresponding angle A 302 that instead represents the foregoing magnitude of the strength of the belief (and where, for example, an angle of 0° represents no such belief and an angle of 90° represents a highest magnitude in these regards, with other ranges being possible as desired).

Accordingly, a vector serving as a partiality vector can have at least one of a magnitude and an angle that corresponds to a magnitude of a particular person's belief in an amount of good that comes from an order associated with a particular partiality.

Applying force to displace an object with mass in the direction of a certain partiality-based order creates worth for a person who has that partiality. The resultant work (i.e., that force multiplied by the distance the object moves) can be viewed as a worth vector having a magnitude equal to the accomplished work and having a direction that represents the corresponding imposed order. If the resultant displacement results in more order of the kind that the person is partial to then the net result is a notion of “good.” This “good” is a real quantity that exists in meta-physical space much like work is a real quantity in material space. The link between the “good” in meta-physical space and the work in material space is that it takes work to impose order that has value.

In the context of a person, this effort can represent, quite literally, the effort that the person is willing to exert to be compliant with (or to otherwise serve) this particular partiality. For example, a person who values animal rights would have a large magnitude worth vector for this value if they exerted considerable physical effort towards this cause by, for example, volunteering at animal shelters or by attending protests of animal cruelty.

While these teachings will readily employ a direct measurement of effort such as work done or time spent, these teachings will also accommodate using an indirect measurement of effort such as expense; in particular, money. In many cases people trade their direct labor for payment. The labor may be manual or intellectual. While salaries and payments can vary significantly from one person to another, a same sense of effort applies at least in a relative sense.

As a very specific example in these regards, there are wristwatches that require a skilled craftsman over a year to make. The actual aggregated amount of force applied to displace the small components that comprise the wristwatch would be relatively very small. That said, the skilled craftsman acquired the necessary skill to so assemble the wristwatch over many years of applying force to displace thousands of little parts when assembly previous wristwatches. That experience, based upon a much larger aggregation of previously-exerted effort, represents a genuine part of the “effort” to make this particular wristwatch and hence is fairly considered as part of the wristwatch's worth.

The conventional forces working in each person's mind are typically more-or-less constantly evaluating the value propositions that correspond to a path of least effort to thereby order their lives towards the things they value. A key reason that happens is because the actual ordering occurs in material space and people must exert real energy in pursuit of their desired ordering. People therefore naturally try to find the path with the least real energy expended that still moves them to the valued order. Accordingly, a trusted value proposition that offers a reduction of real energy will be embraced as being “good” because people will tend to be partial to anything that lowers the real energy they are required to exert while remaining consistent with their partialities.

FIG. 4 presents a space graph that illustrates many of the foregoing points. A first vector 401 represents the time required to make such a wristwatch while a second vector 402 represents the order associated with such a device (in this case, that order essentially represents the skill of the craftsman). These two vectors 401 and 402 in turn sum to form a third vector 403 that constitutes a value vector for this wristwatch. This value vector 403, in turn, is offset with respect to energy (i.e., the energy associated with manufacturing the wristwatch).

A person partial to precision and/or to physically presenting an appearance of success and status (and who presumably has the wherewithal) may, in turn, be willing to spend $100,000 for such a wristwatch. A person able to afford such a price, of course, may themselves be skilled at imposing a certain kind of order that other persons are partial to such that the amount of physical work represented by each spent dollar is small relative to an amount of dollars they receive when exercising their skill(s). (Viewed another way, wearing an expensive wristwatch may lower the effort required for such a person to communicate that their own personal success comes from being highly skilled in a certain order of high worth.)

Generally speaking, all worth comes from imposing order on the material space-time. The worth of a particular order generally increases as the skill required to impose the order increases. Accordingly, unskilled labor may exchange $10 for every hour worked where the work has a high content of unskilled physical labor while a highly-skilled data scientist may exchange $75 for every hour worked with very little accompanying physical effort.

Consider a simple example where both of these laborers are partial to a well-ordered lawn and both have a corresponding partiality vector in those regards with a same magnitude. To observe that partiality the unskilled laborer may own an inexpensive push power lawn mower that this person utilizes for an hour to mow their lawn. The data scientist, on the other hand, pays someone else $75 in this example to mow their lawn. In both cases these two individuals traded one hour of worth creation to gain the same worth (to them) in the form of a well-ordered lawn; the unskilled laborer in the form of direct physical labor and the data scientist in the form of money that required one hour of their specialized effort to earn.

This same vector-based approach can also represent various products and services. This is because products and services have worth (or not) because they can remove effort (or fail to remove effort) out of the customer's life in the direction of the order to which the customer is partial. In particular, a product has a perceived effort embedded into each dollar of cost in the same way that the customer has an amount of perceived effort embedded into each dollar earned. A customer has an increased likelihood of responding to an exchange of value if the vectors for the product and the customer's partiality are directionally aligned and where the magnitude of the vector as represented in monetary cost is somewhat greater than the worth embedded in the customer's dollar.

Put simply, the magnitude (and/or angle) of a partiality vector for a person can represent, directly or indirectly, a corresponding effort the person is willing to exert to pursue that partiality. There are various ways by which that value can be determined. As but one non-limiting example in these regards, the magnitude/angle V of a particular partiality vector can be expressed as:

$$V = [ \begin{matrix}{X}_{1} \\ ⋮ \\ {X}_{n}\end{matrix} ] [ {W}_{1} … {W}_{n} ]$$

where X refers to any of a variety of inputs (such as those described above) that can impact the characterization of a particular partiality (and where these teachings will accommodate either or both subjective and objective inputs as desired) and W refers to weighting factors that are appropriately applied the foregoing input values (and where, for example, these weighting factors can have values that themselves reflect a particular person's consumer personality or otherwise as desired and can be static or dynamically valued in practice as desired).

In the context of a product (or service) the magnitude/angle of the corresponding vector can represent the reduction of effort that must be exerted when making use of this product to pursue that partiality, the effort that was expended in order to create the product/service, the effort that the person perceives can be personally saved while nevertheless promoting the desired order, and/or some other corresponding effort. Taken as a whole the sum of all the vectors must be perceived to increase the overall order to be considered a good product/service.

It may be noted that while reducing effort provides a very useful metric in these regards, it does not necessarily follow that a given person will always gravitate to that which most reduces effort in their life. This is at least because a given person's values (for example) will establish a baseline against which a person may eschew some goods/services that might in fact lead to a greater overall reduction of effort but which would conflict, perhaps fundamentally, with their values. As a simple illustrative example, a given person might value physical activity. Such a person could experience reduced effort (including effort represented via monetary costs) by simply sitting on their couch, but instead will pursue activities that involve that valued physical activity. That said, however, the goods and services that such a person might acquire in support of their physical activities are still likely to represent increased order in the form of reduced effort where that makes sense. For example, a person who favors rock climbing might also favor rock climbing clothing and supplies that render that activity safer to thereby reduce the effort required to prevent disorder as a consequence of a fall (and consequently increasing the good outcome of the rock climber's quality experience).

By forming reliable partiality vectors for various individuals and corresponding product characterization vectors for a variety of products and/or services, these teachings provide a useful and reliable way to identify products/services that accord with a given person's own partialities (whether those partialities are based on their values, their affinities, their preferences, or otherwise).

It is of course possible that partiality vectors may not be available yet for a given person due to a lack of sufficient specific source information from or regarding that person. In this case it may nevertheless be possible to use one or more partiality vector templates that generally represent certain groups of people that fairly include this particular person. For example, if the person's gender, age, academic status/achievements, and/or postal code are known it may be useful to utilize a template that includes one or more partiality vectors that represent some statistical average or norm of other persons matching those same characterizing parameters. (Of course, while it may be useful to at least begin to employ these teachings with certain individuals by using one or more such templates, these teachings will also accommodate modifying (perhaps significantly and perhaps quickly) such a starting point over time as part of developing a more personal set of partiality vectors that are specific to the individual.) A variety of templates could be developed based, for example, on professions, academic pursuits and achievements, nationalities and/or ethnicities, characterizing hobbies, and the like.

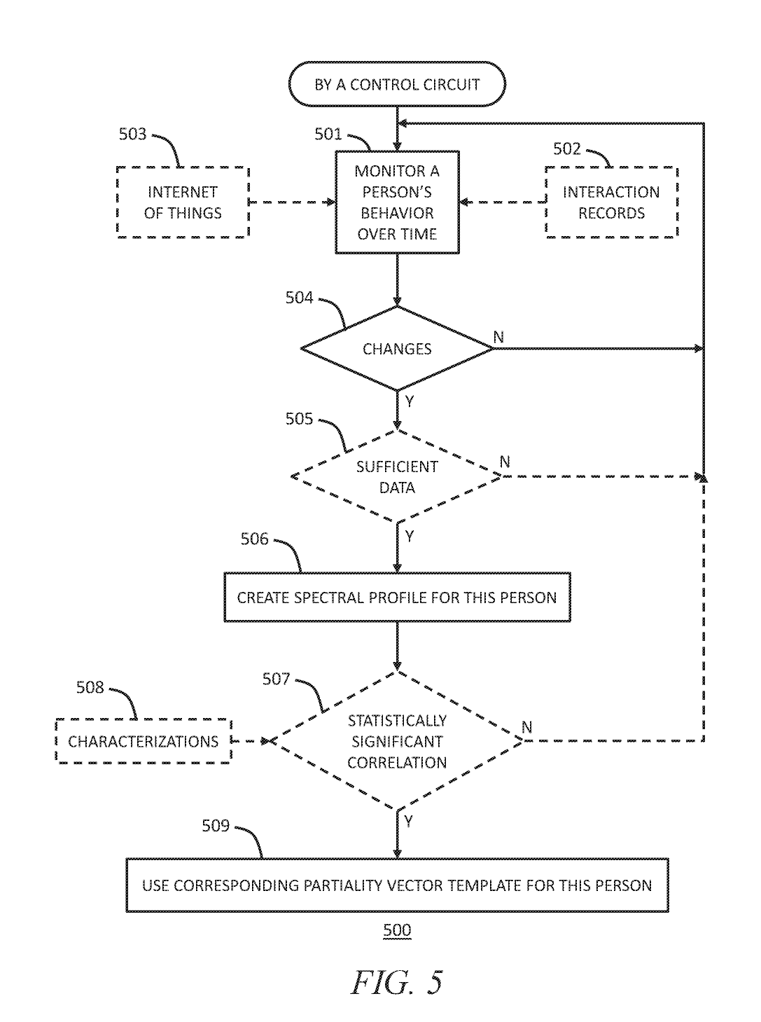

FIG. 5 presents a process 500 that illustrates yet another approach in these regards. For the sake of an illustrative example it will be presumed here that a control circuit of choice (with useful examples in these regards being presented further below) carries out one or more of the described steps/actions.

At block 501 the control circuit monitors a person's behavior over time. The range of monitored behaviors can vary with the individual and the application setting. By one approach, only behaviors that the person has specifically approved for monitoring are so monitored.

As one example in these regards, this monitoring can be based, in whole or in part, upon interaction records 502 that reflect or otherwise track, for example, the monitored person's purchases. This can include specific items purchased by the person, from whom the items were purchased, where the items were purchased, how the items were purchased (for example, at a bricks-and-mortar physical retail shopping facility or via an on-line shopping opportunity), the price paid for the items, and/or which items were returned and when), and so forth.

As another example in these regards the interaction records 502 can pertain to the social networking behaviors of the monitored person including such things as their “likes,” their posted comments, images, and tweets, affinity group affiliations, their on-line profiles, their playlists and other indicated “favorites,” and so forth. Such information can sometimes comprise a direct indication of a particular partiality or, in other cases, can indirectly point towards a particular partiality and/or indicate a relative strength of the person's partiality.

Other interaction records of potential interest include but are not limited to registered political affiliations and activities, credit reports, military-service history, educational and employment history, and so forth.

As another example, in lieu of the foregoing or in combination therewith, this monitoring can be based, in whole or in part, upon sensor inputs from the Internet of Things (IOT) 503. The Internet of Things refers to the Internet-based inter-working of a wide variety of physical devices including but not limited to wearable or carriable devices, vehicles, buildings, and other items that are embedded with electronics, software, sensors, network connectivity, and sometimes actuators that enable these objects to collect and exchange data via the Internet. In particular, the Internet of Things allows people and objects pertaining to people to be sensed and corresponding information to be transferred to remote locations via intervening network infrastructure. Some experts estimate that the Internet of Things will consist of almost 50 billion such objects by 2020. (Further description in these regards appears further herein.)

Depending upon what sensors a person encounters, information can be available regarding a person's travels, lifestyle, calorie expenditure over time, diet, habits, interests and affinities, choices and assumed risks, and so forth. This process 500 will accommodate either or both real-time or non-real time access to such information as well as either or both push and pull-based paradigms.

By monitoring a person's behavior over time a general sense of that person's daily routine can be established (sometimes referred to herein as a routine experiential base state). As a very simple illustrative example, a routine experiential base state can include a typical daily event timeline for the person that represents typical locations that the person visits and/or typical activities in which the person engages. The timeline can indicate those activities that tend to be scheduled (such as the person's time at their place of employment or their time spent at their child's sports practices) as well as visits/activities that are normal for the person though not necessarily undertaken with strict observance to a corresponding schedule (such as visits to local stores, movie theaters, and the homes of nearby friends and relatives).

At block 504 this process 500 provides for detecting changes to that established routine. These teachings are highly flexible in these regards and will accommodate a wide variety of “changes.” Some illustrative examples include but are not limited to changes with respect to a person's travel schedule, destinations visited or time spent at a particular destination, the purchase and/or use of new and/or different products or services, a subscription to a new magazine, a new Rich Site Summary (RSS) feed or a subscription to a new blog, a new “friend” or “connection” on a social networking site, a new person, entity, or cause to follow on a Twitter-like social networking service, enrollment in an academic program, and so forth.

Upon detecting a change, at optional block 505 this process 500 will accommodate assessing whether the detected change constitutes a sufficient amount of data to warrant proceeding further with the process. This assessment can comprise, for example, assessing whether a sufficient number (i.e., a predetermined number) of instances of this particular detected change have occurred over some predetermined period of time. As another example, this assessment can comprise assessing whether the specific details of the detected change are sufficient in quantity and/or quality to warrant further processing. For example, merely detecting that the person has not arrived at their usual 6 PM-Wednesday dance class may not be enough information, in and of itself, to warrant further processing, in which case the information regarding the detected change may be discarded or, in the alternative, cached for further consideration and use in conjunction or aggregation with other, later-detected changes.

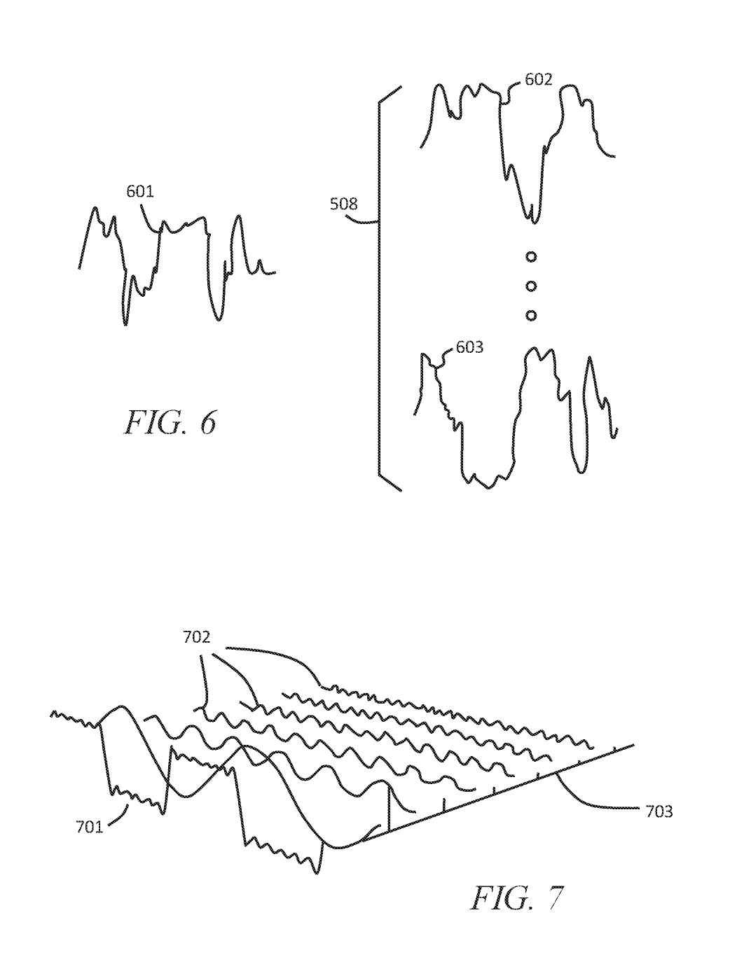

At block 507 this process 500 uses these detected changes to create a spectral profile for the monitored person. FIG. 6 provides an illustrative example in these regards with the spectral profile denoted by reference numeral 601. In this illustrative example the spectral profile 601 represents changes to the person's behavior over a given period of time (such as an hour, a day, a week, or some other temporal window of choice). Such a spectral profile can be as multidimensional as may suit the needs of a given application setting.

At optional block 507 this process 500 then provides for determining whether there is a statistically significant correlation between the aforementioned spectral profile and any of a plurality of like characterizations 508. The like characterizations 508 can comprise, for example, spectral profiles that represent an average of groupings of people who share many of the same (or all of the same) identified partialities. As a very simple illustrative example in these regards, a first such characterization 602 might represent a composite view of a first group of people who have three similar partialities but a dissimilar fourth partiality while another of the characterizations 603 might represent a composite view of a different group of people who share all four partialities.

The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines. Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the population of people upon which each of the characterizations 508 are based and/or the amount of data and/or the duration of time over which data is available for the monitored person.

Referring now to FIG. 7, by one approach the selected characterization (denoted by reference numeral 701 in this figure) comprises an activity profile over time of one or more human behaviors. Examples of behaviors include but are not limited to such things as repeated purchases over time of particular commodities, repeated visits over time to particular locales such as certain restaurants, retail outlets, athletic or entertainment facilities, and so forth, and repeated activities over time such as floor cleaning, dish washing, car cleaning, cooking, volunteering, and so forth. Those skilled in the art will understand and appreciate, however, that the selected characterization is not, in and of itself, demographic data (as described elsewhere herein).

More particularly, the characterization 701 can represent (in this example, for a plurality of different behaviors) each instance over the monitored/sampled period of time when the monitored/represented person engages in a particular represented behavior (such as visiting a neighborhood gym, purchasing a particular product (such as a consumable perishable or a cleaning product), interacts with a particular affinity group via social networking, and so forth). The relevant overall time frame can be chosen as desired and can range in a typical application setting from a few hours or one day to many days, weeks, or even months or years. (It will be understood by those skilled in the art that the particular characterization shown in FIG. 7 is intended to serve an illustrative purpose and does not necessarily represent or mimic any particular behavior or set of behaviors).

Generally speaking it is anticipated that many behaviors of interest will occur at regular or somewhat regular intervals and hence will have a corresponding frequency or periodicity of occurrence. For some behaviors that frequency of occurrence may be relatively often (for example, oral hygiene events that occur at least once, and often multiple times each day) while other behaviors (such as the preparation of a holiday meal) may occur much less frequently (such as only once, or only a few times, each year). For at least some behaviors of interest that general (or specific) frequency of occurrence can serve as a significant indication of a person's corresponding partialities.

By one approach, these teachings will accommodate detecting and timestamping each and every event/activity/behavior or interest as it happens. Such an approach can be memory intensive and require considerable supporting infrastructure.

The present teachings will also accommodate, however, using any of a variety of sampling periods in these regards. In some cases, for example, the sampling period per se may be one week in duration. In that case, it may be sufficient to know that the monitored person engaged in a particular activity (such as cleaning their car) a certain number of times during that week without known precisely when, during that week, the activity occurred. In other cases it may be appropriate or even desirable, to provide greater granularity in these regards. For example, it may be better to know which days the person engaged in the particular activity or even the particular hour of the day. Depending upon the selected granularity/resolution, selecting an appropriate sampling window can help reduce data storage requirements (and/or corresponding analysis/processing overhead requirements).

Although a given person's behaviors may not, strictly speaking, be continuous waves (as shown in FIG. 7) in the same sense as, for example, a radio or acoustic wave, it will nevertheless be understood that such a behavioral characterization 701 can itself be broken down into a plurality of sub-waves 702 that, when summed together, equal or at least approximate to some satisfactory degree the behavioral characterization 701 itself (The more-discrete and sometimes less-rigidly periodic nature of the monitored behaviors may introduce a certain amount of error into the corresponding sub-waves. There are various mathematically satisfactory ways by which such error can be accommodated including by use of weighting factors and/or expressed tolerances that correspond to the resultant sub-waves.)

It should also be understood that each such sub-wave can often itself be associated with one or more corresponding discrete partialities. For example, a partiality reflecting concern for the environment may, in turn, influence many of the included behavioral events (whether they are similar or dissimilar behaviors or not) and accordingly may, as a sub-wave, comprise a relatively significant contributing factor to the overall set of behaviors as monitored over time. These sub-waves (partialities) can in turn be clearly revealed and presented by employing a transform (such as a Fourier transform) of choice to yield a spectral profile 703 wherein the X axis represents frequency and the Y axis represents the magnitude of the response of the monitored person at each frequency/sub-wave of interest.

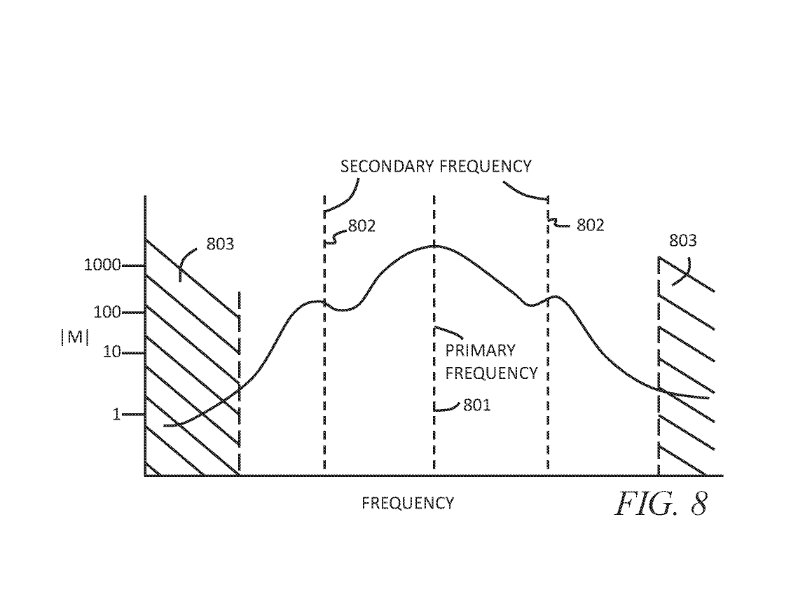

This spectral response of a given individual—which is generated from a time series of events that reflect/track that person's behavior—yields frequency response characteristics for that person that are analogous to the frequency response characteristics of physical systems such as, for example, an analog or digital filter or a second order electrical or mechanical system. Referring to FIG. 8, for many people the spectral profile of the individual person will exhibit a primary frequency 801 for which the greatest response (perhaps many orders of magnitude greater than other evident frequencies) to life is exhibited and apparent. In addition, the spectral profile may also possibly identify one or more secondary frequencies 802 above and/or below that primary frequency 801. (It may be useful in many application settings to filter out more distant frequencies 803 having considerably lower magnitudes because of a reduced likelihood of relevance and/or because of a possibility of error in those regards; in effect, these lower-magnitude signals constitute noise that such filtering can remove from consideration.)

As noted above, the present teachings will accommodate using sampling windows of varying size. By one approach the frequency of events that correspond to a particular partiality can serve as a basis for selecting a particular sampling rate to use when monitoring for such events. For example, Nyquist-based sampling rules (which dictate sampling at a rate at least twice that of the frequency of the signal of interest) can lead one to choose a particular sampling rate (and the resultant corresponding sampling window size).

As a simple illustration, if the activity of interest occurs only once a week, then using a sampling of half-a-week and sampling twice during the course of a given week will adequately capture the monitored event. If the monitored person's behavior should change, a corresponding change can be automatically made. For example, if the person in the foregoing example begins to engage in the specified activity three times a week, the sampling rate can be switched to six times per week (in conjunction with a sampling window that is resized accordingly).

By one approach, the sampling rate can be selected and used on a partiality-by-partiality basis. This approach can be especially useful when different monitoring modalities are employed to monitor events that correspond to different partialities. If desired, however, a single sampling rate can be employed and used for a plurality (or even all) partialities/behaviors. In that case, it can be useful to identify the behavior that is exemplified most often (i.e., that behavior which has the highest frequency) and then select a sampling rate that is at least twice that rate of behavioral realization, as that sampling rate will serve well and suffice for both that highest-frequency behavior and all lower-frequency behaviors as well.

It can be useful in many application settings to assume that the foregoing spectral profile of a given person is an inherent and inertial characteristic of that person and that this spectral profile, in essence, provides a personality profile of that person that reflects not only how but why this person responds to a variety of life experiences. More importantly, the partialities expressed by the spectral profile for a given person will tend to persist going forward and will not typically change significantly in the absence of some powerful external influence (including but not limited to significant life events such as, for example, marriage, children, loss of job, promotion, and so forth).

In any event, by knowing a priori the particular partialities (and corresponding strengths) that underlie the particular characterization 701, those partialities can be used as an initial template for a person whose own behaviors permit the selection of that particular characterization 701. In particular, those particularities can be used, at least initially, for a person for whom an amount of data is not otherwise available to construct a similarly rich set of partiality information.

As a very specific and non-limiting example, per these teachings the choice to make a particular product can include consideration of one or more value systems of potential customers. When considering persons who value animal rights, a product conceived to cater to that value proposition may require a corresponding exertion of additional effort to order material space-time such that the product is made in a way that (A) does not harm animals and/or (even better) (B) improves life for animals (for example, eggs obtained from free range chickens). The reason a person exerts effort to order material space-time is because they believe it is good to do and/or not good to not do so. When a person exerts effort to do good (per their personal standard of “good”) and if that person believes that a particular order in material space-time (that includes the purchase of a particular product) is good to achieve, then that person will also believe that it is good to buy as much of that particular product (in order to achieve that good order) as their finances and needs reasonably permit (all other things being equal).

The aforementioned additional effort to provide such a product can (typically) convert to a premium that adds to the price of that product. A customer who puts out extra effort in their life to value animal rights will typically be willing to pay that extra premium to cover that additional effort exerted by the company. By one approach a magnitude that corresponds to the additional effort exerted by the company can be added to the person's corresponding value vector because a product or service has worth to the extent that the product/service allows a person to order material space-time in accordance with their own personal value system while allowing that person to exert less of their own effort in direct support of that value (since money is a scalar form of effort).

By one approach there can be hundreds or even thousands of identified partialities. In this case, if desired, each product/service of interest can be assessed with respect to each and every one of these partialities and a corresponding partiality vector formed to thereby build a collection of partiality vectors that collectively characterize the product/service. As a very simple example in these regards, a given laundry detergent might have a cleanliness partiality vector with a relatively high magnitude (representing the effectiveness of the detergent), a ecology partiality vector that might be relatively low or possibly even having a negative magnitude (representing an ecologically disadvantageous effect of the detergent post usage due to increased disorder in the environment), and a simple-life partiality vector with only a modest magnitude (representing the relative ease of use of the detergent but also that the detergent presupposes that the user has a modern washing machine). Other partiality vectors for this detergent, representing such things as nutrition or mental acuity, might have magnitudes of zero.

As mentioned above, these teachings can accommodate partiality vectors having a negative magnitude. Consider, for example, a partiality vector representing a desire to order things to reduce one's so-called carbon footprint. A magnitude of zero for this vector would indicate a completely neutral effect with respect to carbon emissions while any positive-valued magnitudes would represent a net reduction in the amount of carbon in the atmosphere, hence increasing the ability of the environment to be ordered. Negative magnitudes would represent the introduction of carbon emissions that increases disorder of the environment (for example, as a result of manufacturing the product, transporting the product, and/or using the product)

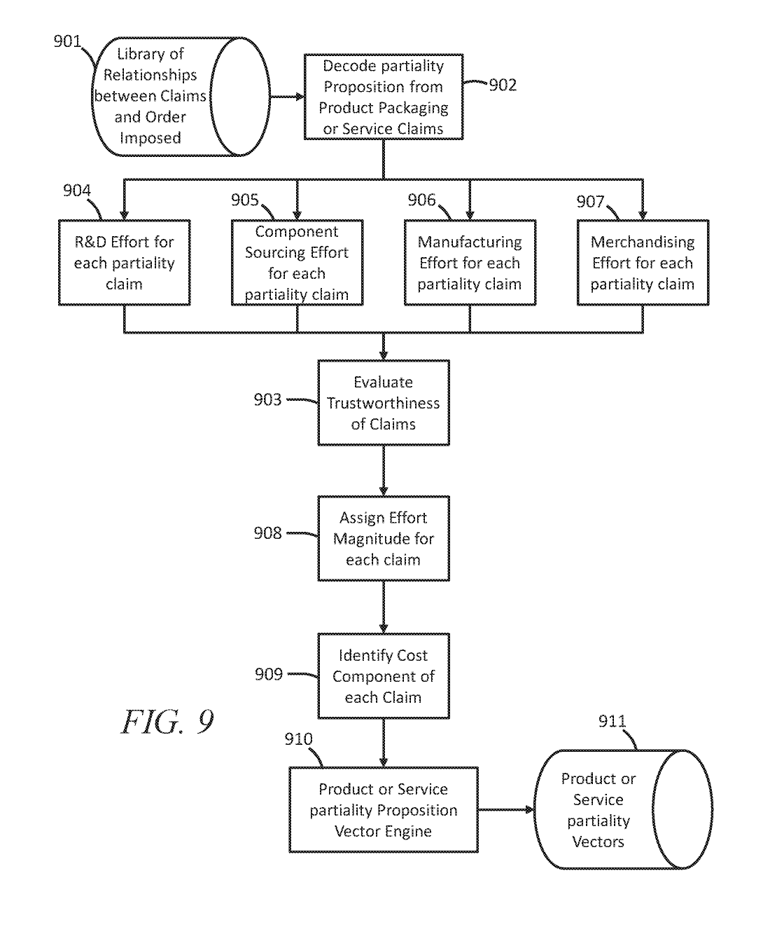

FIG. 9 presents one non-limiting illustrative example in these regards. The illustrated process presumes the availability of a library 901 of correlated relationships between product/service claims and particular imposed orders. Examples of product/service claims include such things as claims that a particular product results in cleaner laundry or household surfaces, or that a particular product is made in a particular political region (such as a particular state or country), or that a particular product is better for the environment, and so forth. The imposed orders to which such claims are correlated can reflect orders as described above that pertain to corresponding partialities.

At block 902 this process provides for decoding one or more partiality propositions from specific product packaging (or service claims). For example, the particular textual/graphics-based claims presented on the packaging of a given product can be used to access the aforementioned library 901 to identify one or more corresponding imposed orders from which one or more corresponding partialities can then be identified.

At block 903 this process provides for evaluating the trustworthiness of the aforementioned claims. This evaluation can be based upon any one or more of a variety of data points as desired. FIG. 9 illustrates four significant possibilities in these regards. For example, at block 904 an actual or estimated research and development effort can be quantified for each claim pertaining to a partiality. At block 905 an actual or estimated component sourcing effort for the product in question can be quantified for each claim pertaining to a partiality. At block 906 an actual or estimated manufacturing effort for the product in question can be quantified for each claim pertaining to a partiality. And at block 907 an actual or estimated merchandising effort for the product in question can be quantified for each claim pertaining to a partiality.

If desired, a product claim lacking sufficient trustworthiness may simply be excluded from further consideration. By another approach the product claim can remain in play but a lack of trustworthiness can be reflected, for example, in a corresponding partiality vector direction or magnitude for this particular product.

At block 908 this process provides for assigning an effort magnitude for each evaluated product/service claim. That effort can constitute a one-dimensional effort (reflecting, for example, only the manufacturing effort) or can constitute a multidimensional effort that reflects, for example, various categories of effort such as the aforementioned research and development effort, component sourcing effort, manufacturing effort, and so forth.

At block 909 this process provides for identifying a cost component of each claim, this cost component representing a monetary value. At block 910 this process can use the foregoing information with a product/service partiality propositions vector engine to generate a library 911 of one or more corresponding partiality vectors for the processed products/services. Such a library can then be used as described herein in conjunction with partiality vector information for various persons to identify, for example, products/services that are well aligned with the partialities of specific individuals.

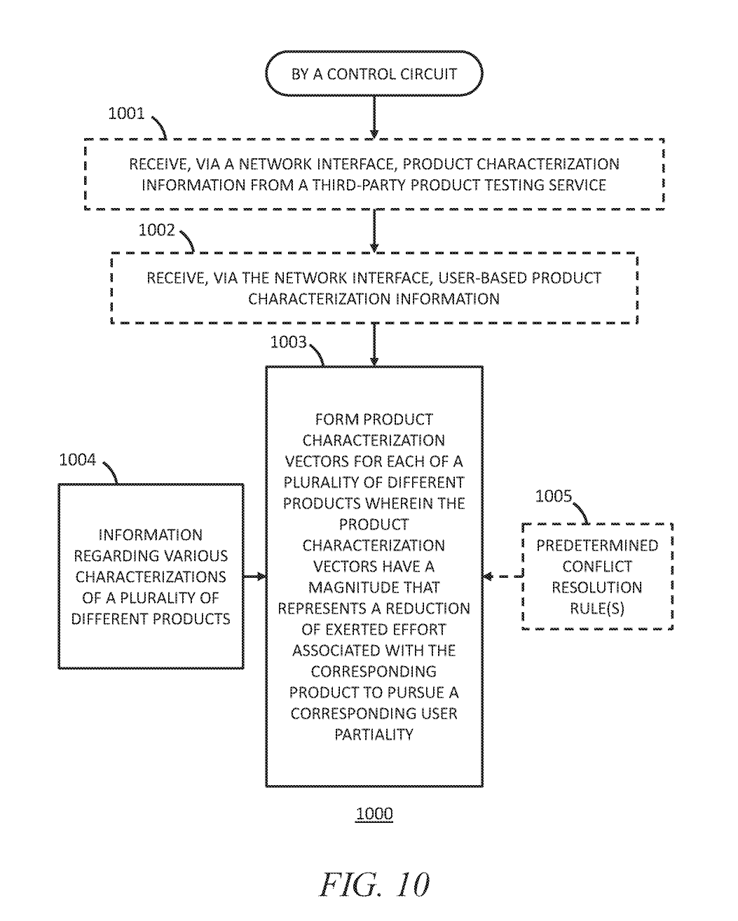

FIG. 10 provides another illustrative example in these same regards and may be employed in lieu of the foregoing or in total or partial combination therewith. Generally speaking, this process 1000 serves to facilitate the formation of product characterization vectors for each of a plurality of different products where the magnitude of the vector length (and/or the vector angle) has a magnitude that represents a reduction of exerted effort associated with the corresponding product to pursue a corresponding user partiality.

By one approach, and as illustrated in FIG. 10, this process 1000 can be carried out by a control circuit of choice. Specific examples of control circuits are provided elsewhere herein.

As described further herein in detail, this process 1000 makes use of information regarding various characterizations of a plurality of different products. These teachings are highly flexible in practice and will accommodate a wide variety of possible information sources and types of information. By one optional approach, and as shown at optional block 1001, the control circuit can receive (for example, via a corresponding network interface of choice) product characterization information from a third-party product testing service. The magazine/web resource Consumers Report provides one useful example in these regards. Such a resource provides objective content based upon testing, evaluation, and comparisons (and sometimes also provides subjective content regarding such things as aesthetics, ease of use, and so forth) and this content, provided as-is or pre-processed as desired, can readily serve as useful third-party product testing service product characterization information.

As another example, any of a variety of product-testing blogs that are published on the Internet can be similarly accessed and the product characterization information available at such resources harvested and received by the control circuit. (The expression “third party” will be understood to refer to an entity other than the entity that operates/controls the control circuit and other than the entity that provides the corresponding product itself.)

As another example, and as illustrated at optional block 1002, the control circuit can receive (again, for example, via a network interface of choice) user-based product characterization information. Examples in these regards include but are not limited to user reviews provided on-line at various retail sites for products offered for sale at such sites. The reviews can comprise metricized content (for example, a rating expressed as a certain number of stars out of a total available number of stars, such as 3 stars out of 5 possible stars) and/or text where the reviewers can enter their objective and subjective information regarding their observations and experiences with the reviewed products. In this case, “user-based” will be understood to refer to users who are not necessarily professional reviewers (though it is possible that content from such persons may be included with the information provided at such a resource) but who presumably purchased the product being reviewed and who have personal experience with that product that forms the basis of their review. By one approach the resource that offers such content may constitute a third party as defined above, but these teachings will also accommodate obtaining such content from a resource operated or sponsored by the enterprise that controls/operates this control circuit.

In any event, this process 1000 provides for accessing (see block 1004) information regarding various characterizations of each of a plurality of different products. This information 1004 can be gleaned as described above and/or can be obtained and/or developed using other resources as desired. As one illustrative example in these regards, the manufacturer and/or distributor of certain products may source useful content in these regards.

These teachings will accommodate a wide variety of information sources and types including both objective characterizing and/or subjective characterizing information for the aforementioned products.

Examples of objective characterizing information include, but are not limited to, ingredients information (i.e., specific components/materials from which the product is made), manufacturing locale information (such as country of origin, state of origin, municipality of origin, region of origin, and so forth), efficacy information (such as metrics regarding the relative effectiveness of the product to achieve a particular end-use result), cost information (such as per product, per ounce, per application or use, and so forth), availability information (such as present in-store availability, on-hand inventory availability at a relevant distribution center, likely or estimated shipping date, and so forth), environmental impact information (regarding, for example, the materials from which the product is made, one or more manufacturing processes by which the product is made, environmental impact associated with use of the product, and so forth), and so forth.

Examples of subjective characterizing information include but are not limited to user sensory perception information (regarding, for example, heaviness or lightness, speed of use, effort associated with use, smell, and so forth), aesthetics information (regarding, for example, how attractive or unattractive the product is in appearance, how well the product matches or accords with a particular design paradigm or theme, and so forth), trustworthiness information (regarding, for example, user perceptions regarding how likely the product is perceived to accomplish a particular purpose or to avoid causing a particular collateral harm), trendiness information, and so forth.

This information 1004 can be curated (or not), filtered, sorted, weighted (in accordance with a relative degree of trust, for example, accorded to a particular source of particular information), and otherwise categorized and utilized as desired. As one simple example in these regards, for some products it may be desirable to only use relatively fresh information (i.e., information not older than some specific cut-off date) while for other products it may be acceptable (or even desirable) to use, in lieu of fresh information or in combination therewith, relatively older information. As another simple example, it may be useful to use only information from one particular geographic region to characterize a particular product and to therefore not use information from other geographic regions.

At block 1003 the control circuit uses the foregoing information 1004 to form product characterization vectors for each of the plurality of different products. By one approach these product characterization vectors have a magnitude (for the length of the vector and/or the angle of the vector) that represents a reduction of exerted effort associated with the corresponding product to pursue a corresponding user partiality (as is otherwise discussed herein).

It is possible that a conflict will become evident as between various ones of the aforementioned items of information 1004. In particular, the available characterizations for a given product may not all be the same or otherwise in accord with one another. In some cases it may be appropriate to literally or effectively calculate and use an average to accommodate such a conflict. In other cases it may be useful to use one or more other predetermined conflict resolution rules 1005 to automatically resolve such conflicts when forming the aforementioned product characterization vectors.

These teachings will accommodate any of a variety of rules in these regards. By one approach, for example, the rule can be based upon the age of the information (where, for example the older (or newer, if desired) data is preferred or weighted more heavily than the newer (or older, if desired) data. By another approach, the rule can be based upon a number of user reviews upon which the user-based product characterization information is based (where, for example, the rule specifies that whichever user-based product characterization information is based upon a larger number of user reviews will prevail in the event of a conflict). By another approach, the rule can be based upon information regarding historical accuracy of information from a particular information source (where, for example, the rule specifies that information from a source with a better historical record of accuracy shall prevail over information from a source with a poorer historical record of accuracy in the event of a conflict).

By yet another approach, the rule can be based upon social media. For example, social media-posted reviews may be used as a tie-breaker in the event of a conflict between other more-favored sources. By another approach, the rule can be based upon a trending analysis. And by yet another approach the rule can be based upon the relative strength of brand awareness for the product at issue (where, for example, the rule specifies resolving a conflict in favor of a more favorable characterization when dealing with a product from a strong brand that evidences considerable consumer goodwill and trust).

It will be understood that the foregoing examples are intended to serve an illustrative purpose and are not offered as an exhaustive listing in these regards. It will also be understood that any two or more of the foregoing rules can be used in combination with one another to resolve the aforementioned conflicts.

By one approach the aforementioned product characterization vectors are formed to serve as a universal characterization of a given product. By another approach, however, the aforementioned information 1004 can be used to form product characterization vectors for a same characterization factor for a same product to thereby correspond to different usage circumstances of that same product. Those different usage circumstances might comprise, for example, different geographic regions of usage, different levels of user expertise (where, for example, a skilled, professional user might have different needs and expectations for the product than a casual, lay user), different levels of expected use, and so forth. In particular, the different vectorized results for a same characterization factor for a same product may have differing magnitudes from one another to correspond to different amounts of reduction of the exerted effort associated with that product under the different usage circumstances.

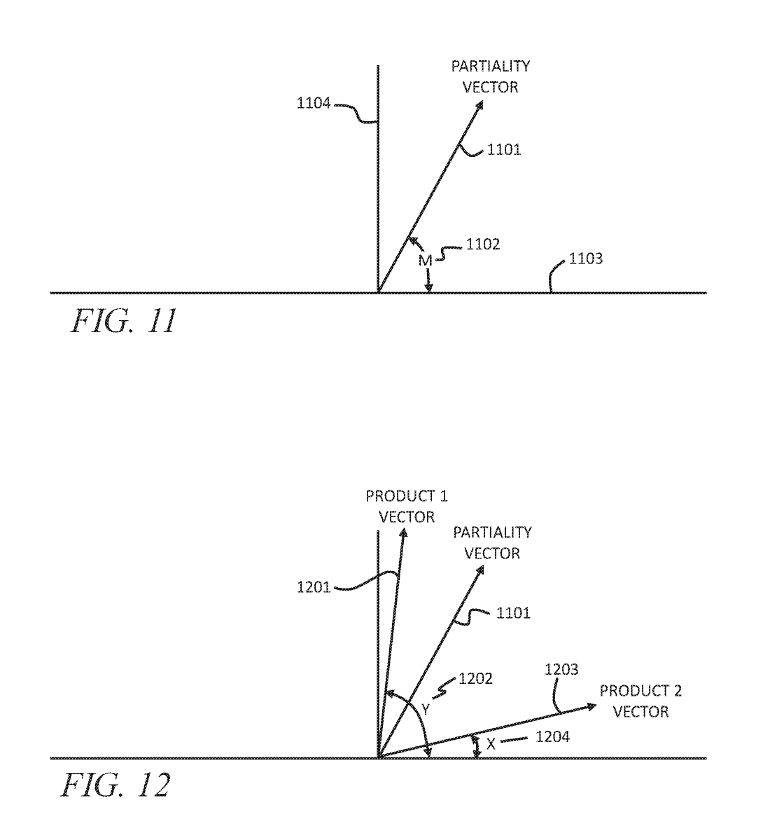

As noted above, the magnitude corresponding to a particular partiality vector for a particular person can be expressed by the angle of that partiality vector. FIG. 11 provides an illustrative example in these regards. In this example the partiality vector 1101 has an angle M 1102 (and where the range of available positive magnitudes range from a minimal magnitude represented by 0° (as denoted by reference numeral 1103) to a maximum magnitude represented by 90° (as denoted by reference numeral 1104)). Accordingly, the person to whom this partiality vector 1001 pertains has a relatively strong (but not absolute) belief in an amount of good that comes from an order associated with that partiality.

FIG. 12, in turn, presents that partiality vector 1101 in context with the product characterization vectors 1201 and 1203 for a first product and a second product, respectively. In this example the product characterization vector 1201 for the first product has an angle Y 1202 that is greater than the angle M 1102 for the aforementioned partiality vector 1101 by a relatively small amount while the product characterization vector 1203 for the second product has an angle X 1204 that is considerably smaller than the angle M 1102 for the partiality vector 1101.

Since, in this example, the angles of the various vectors represent the magnitude of the person's specified partiality or the extent to which the product aligns with that partiality, respectively, vector dot product calculations can serve to help identify which product best aligns with this partiality. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

This operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. As regards the present illustrative example, the resultant scaler value for the vector dot product of the product 1 vector 1201 with the partiality vector 1101 will be larger than the resultant scaler value for the vector dot product of the product 2 vector 1203 with the partiality vector 1101. Accordingly, when using vector angles to impart this magnitude information, the vector dot product operation provides a simple and convenient way to determine proximity between a particular partiality and the performance/properties of a particular product to thereby greatly facilitate identifying a best product amongst a plurality of candidate products.

By way of further illustration, consider an example where a particular consumer as a strong partiality for organic produce and is financially able to afford to pay to observe that partiality. A dot product result for that person with respect to a product characterization vector(s) for organic apples that represent a cost of $10 on a weekly basis (i.e., Cv·P1v) might equal (1,1), hence yielding a scalar result of ∥1∥ (where Cv refers to the corresponding partiality vector for this person and Ply represents the corresponding product characterization vector for these organic apples). Conversely, a dot product result for this same person with respect to a product characterization vector(s) for non-organic apples that represent a cost of $5 on a weekly basis (i.e., Cv−P2v) might instead equal (1,0), hence yielding a scalar result of ∥½∥. Accordingly, although the organic apples cost more than the non-organic apples, the dot product result for the organic apples exceeds the dot product result for the non-organic apples and therefore identifies the more expensive organic apples as being the best choice for this person.

To continue with the foregoing example, consider now what happens when this person subsequently experiences some financial misfortune (for example, they lose their job and have not yet found substitute employment). Such an event can present the “force” necessary to alter the previously-established “inertia” of this person's steady-state partialities; in particular, these negatively-changed financial circumstances (in this example) alter this person's budget sensitivities (though not, of course their partiality for organic produce as compared to non-organic produce). The scalar result of the dot product for the $5/week non-organic apples may remain the same (i.e., in this example, ∥½∥), but the dot product for the $10/week organic apples may now drop (for example, to ∥½∥ as well). Dropping the quantity of organic apples purchased, however, to reflect the tightened financial circumstances for this person may yield a better dot product result. For example, purchasing only $5 (per week) of organic apples may produce a dot product result of ∥1∥. The best result for this person, then, under these circumstances, is a lesser quantity of organic apples rather than a larger quantity of non-organic apples.

In a typical application setting, it is possible that this person's loss of employment is not, in fact, known to the system. Instead, however, this person's change of behavior (i.e., reducing the quantity of the organic apples that are purchased each week) might well be tracked and processed to adjust one or more partialities (either through an addition or deletion of one or more partialities and/or by adjusting the corresponding partiality magnitude) to thereby yield this new result as a preferred result.

The foregoing simple examples clearly illustrate that vector dot product approaches can be a simple yet powerful way to quickly eliminate some product options while simultaneously quickly highlighting one or more product options as being especially suitable for a given person.

Such vector dot product calculations and results, in turn, help illustrate another point as well. As noted above, sine waves can serve as a potentially useful way to characterize and view partiality information for both people and products/services. In those regards, it is worth noting that a vector dot product result can be a positive, zero, or even negative value. That, in turn, suggests representing a particular solution as a normalization of the dot product value relative to the maximum possible value of the dot product. Approached this way, the maximum amplitude of a particular sine wave will typically represent a best solution.

Taking this approach further, by one approach the frequency (or, if desired, phase) of the sine wave solution can provide an indication of the sensitivity of the person to product choices (for example, a higher frequency can indicate a relatively highly reactive sensitivity while a lower frequency can indicate the opposite). A highly sensitive person is likely to be less receptive to solutions that are less than fully optimum and hence can help to narrow the field of candidate products while, conversely, a less sensitive person is likely to be more receptive to solutions that are less than fully optimum and can help to expand the field of candidate products.

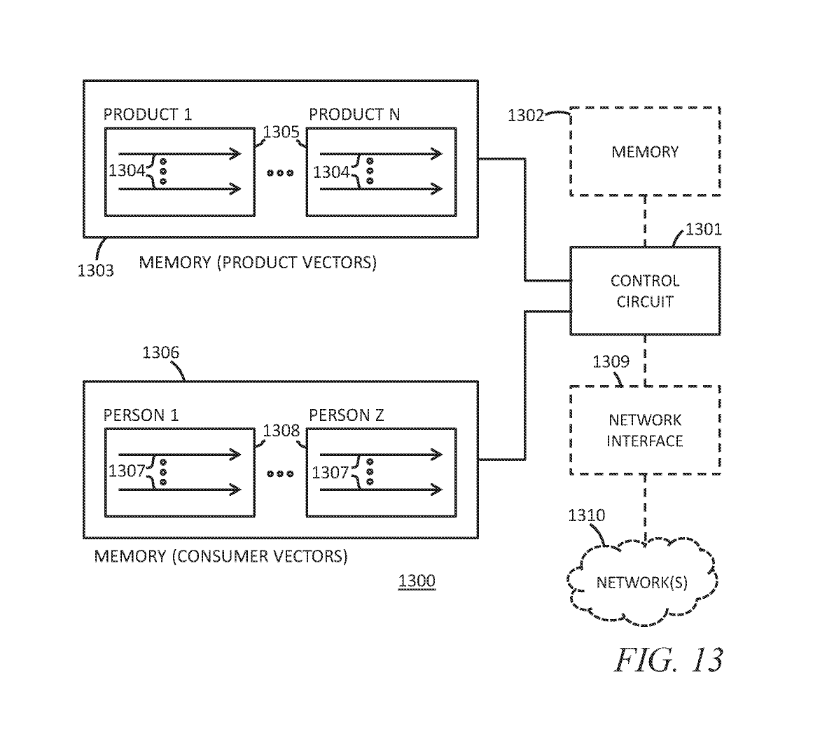

FIG. 13 presents an illustrative apparatus 1300 for conducting, containing, and utilizing the foregoing content and capabilities. In this particular example, the enabling apparatus 1300 includes a control circuit 1301. Being a “circuit,” the control circuit 1301 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 1301 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 1301 is configured (for example, by using corresponding programming as will be well understood by those skilled in the art) to carry out one or more of the steps, actions, and/or functions described herein.

By one optional approach the control circuit 1301 operably couples to a memory 1302. This memory 1302 may be integral to the control circuit 1301 or can be physically discrete (in whole or in part) from the control circuit 1301 as desired. This memory 1302 can also be local with respect to the control circuit 1301 (where, for example, both share a common circuit board, chassis, power supply, and/or housing) or can be partially or wholly remote with respect to the control circuit 1301 (where, for example, the memory 1302 is physically located in another facility, metropolitan area, or even country as compared to the control circuit 1301).

This memory 1302 can serve, for example, to non-transitorily store the computer instructions that, when executed by the control circuit 1301, cause the control circuit 1301 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

Either stored in this memory 1302 or, as illustrated, in a separate memory 1303 are the vectorized characterizations 1304 for each of a plurality of products 1305 (represented here by a first product through an Nth product where “N” is an integer greater than “1”). In addition, and again either stored in this memory 1302 or, as illustrated, in a separate memory 1306 are the vectorized characterizations 1307 for each of a plurality of individual persons 1308 (represented here by a first person through a Zth person wherein “Z” is also an integer greater than “1”).

In this example the control circuit 1301 also operably couples to a network interface 1309. So configured the control circuit 1301 can communicate with other elements (both within the apparatus 1300 and external thereto) via the network interface 1309. Network interfaces, including both wireless and non-wireless platforms, are well understood in the art and require no particular elaboration here. This network interface 1309 can compatibly communicate via whatever network or networks 1310 may be appropriate to suit the particular needs of a given application setting. Both communication networks and network interfaces are well understood areas of prior art endeavor and therefore no further elaboration will be provided here in those regards for the sake of brevity.

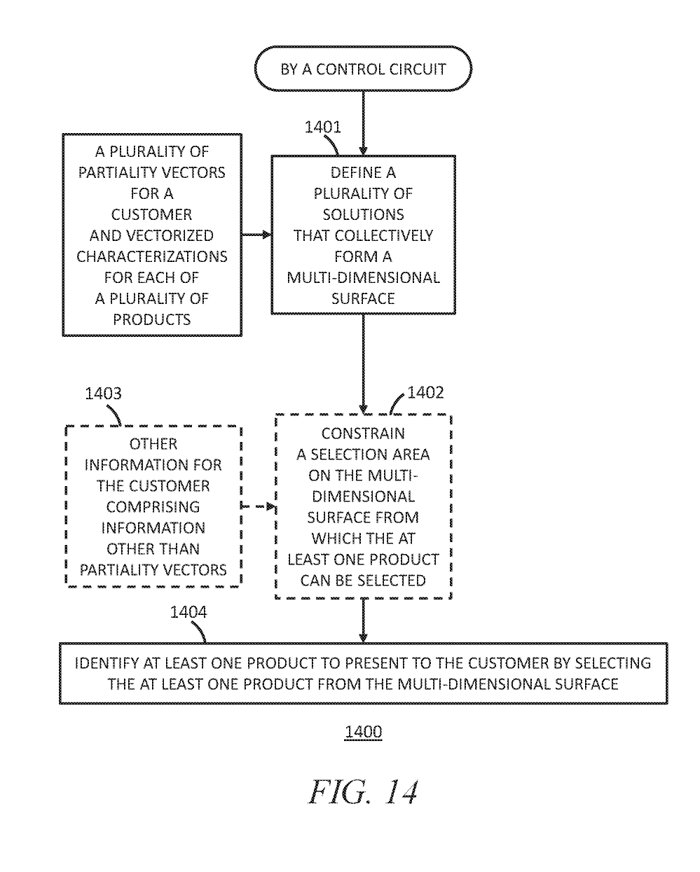

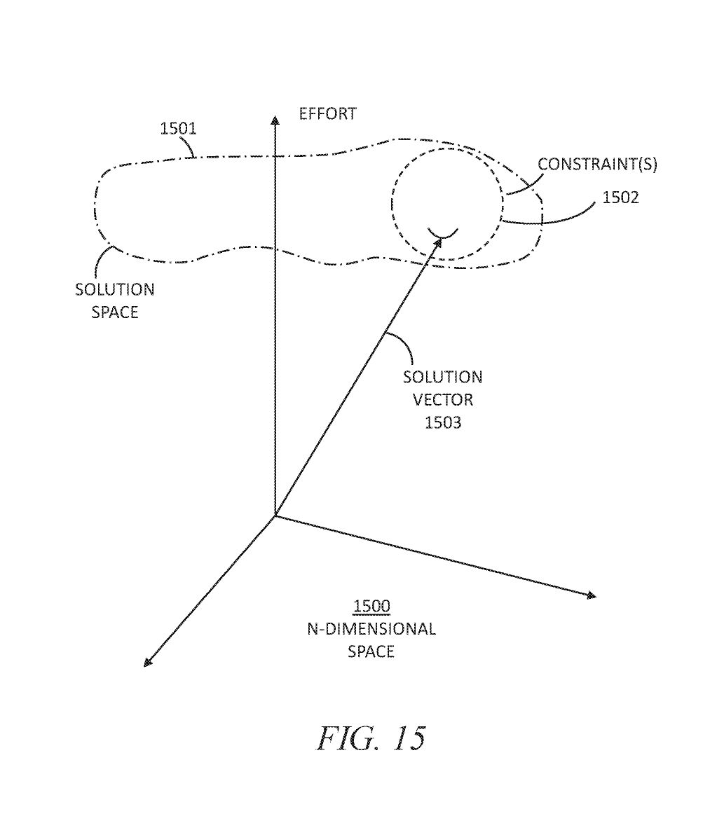

By one approach, and referring now to FIG. 14, the control circuit 1301 is configured to use the aforementioned partiality vectors 1307 and the vectorized product characterizations 1304 to define a plurality of solutions that collectively form a multidimensional surface (per block 1401). FIG. 15 provides an illustrative example in these regards. FIG. 15 represents an N-dimensional space 1500 and where the aforementioned information for a particular customer yielded a multi-dimensional surface denoted by reference numeral 1501. (The relevant value space is an N-dimensional space where the belief in the value of a particular ordering of one's life only acts on value propositions in that space as a function of a least-effort functional relationship.)

Generally speaking, this surface 1501 represents all possible solutions based upon the foregoing information. Accordingly, in a typical application setting this surface 1501 will contain/represent a plurality of discrete solutions. That said, and also in a typical application setting, not all of those solutions will be similarly preferable. Instead, one or more of those solutions may be particularly useful/appropriate at a given time, in a given place, for a given customer.

With continued reference to FIGS. 14 and 15, at optional block 1402 the control circuit 1301 can be configured to use information for the customer 1403 (other than the aforementioned partiality vectors 1307) to constrain a selection area 1502 on the multi-dimensional surface 1501 from which at least one product can be selected for this particular customer. By one approach, for example, the constraints can be selected such that the resultant selection area 1502 represents the best 95th percentile of the solution space. Other target sizes for the selection area 1502 are of course possible and may be useful in a given application setting.

The aforementioned other information 1403 can comprise any of a variety of information types. By one approach, for example, this other information comprises objective information. (As used herein, “objective information” will be understood to constitute information that is not influenced by personal feelings or opinions and hence constitutes unbiased, neutral facts.)

One particularly useful category of objective information comprises objective information regarding the customer. Examples in these regards include, but are not limited to, location information regarding a past, present, or planned/scheduled future location of the customer, budget information for the customer or regarding which the customer must strive to adhere (such that, by way of example, a particular product/solution area may align extremely well with the customer's partialities but is well beyond that which the customer can afford and hence can be reasonably excluded from the selection area 1502), age information for the customer, and gender information for the customer. Another example in these regards is information comprising objective logistical information regarding providing particular products to the customer. Examples in these regards include but are not limited to current or predicted product availability, shipping limitations (such as restrictions or other conditions that pertain to shipping a particular product to this particular customer at a particular location), and other applicable legal limitations (pertaining, for example, to the legality of a customer possessing or using a particular product at a particular location).

At block 1404 the control circuit 1301 can then identify at least one product to present to the customer by selecting that product from the multi-dimensional surface 1501. In the example of FIG. 15, where constraints have been used to define a reduced selection area 1502, the control circuit 1301 is constrained to select that product from within that selection area 1502. For example, and in accordance with the description provided herein, the control circuit 1301 can select that product via solution vector 1503 by identifying a particular product that requires a minimal expenditure of customer effort while also remaining compliant with one or more of the applied objective constraints based, for example, upon objective information regarding the customer and/or objective logistical information regarding providing particular products to the customer.

So configured, and as a simple example, the control circuit 1301 may respond per these teachings to learning that the customer is planning a party that will include seven other invited individuals. The control circuit 1301 may therefore be looking to identify one or more particular beverages to present to the customer for consideration in those regards. The aforementioned partiality vectors 1307 and vectorized product characterizations 1304 can serve to define a corresponding multi-dimensional surface 1501 that identifies various beverages that might be suitable to consider in these regards.

Objective information regarding the customer and/or the other invited persons, however, might indicate that all or most of the participants are not of legal drinking age. In that case, that objective information may be utilized to constrain the available selection area 1502 to beverages that contain no alcohol. As another example in these regards, the control circuit 1301 may have objective information that the party is to be held in a state park that prohibits alcohol and may therefore similarly constrain the available selection area 1502 to beverages that contain no alcohol.

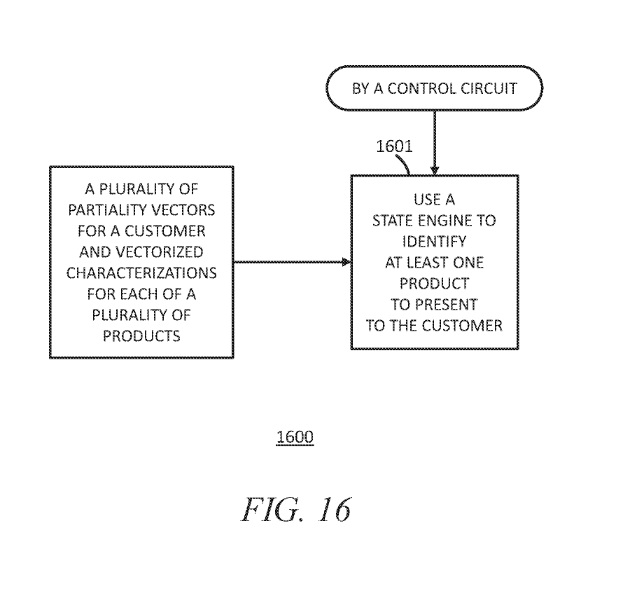

As described above, the aforementioned control circuit 1301 can utilize information including a plurality of partiality vectors for a particular customer along with vectorized product characterizations for each of a plurality of products to identify at least one product to present to a customer. By one approach 1600, and referring to FIG. 16, the control circuit 1301 can be configured as (or to use) a state engine to identify such a product (as indicated at block 1601). As used herein, the expression “state engine” will be understood to refer to a finite-state machine, also sometimes known as a finite-state automaton or simply as a state machine.

Generally speaking, a state engine is a basic approach to designing both computer programs and sequential logic circuits. A state engine has only a finite number of states and can only be in one state at a time. A state engine can change from one state to another when initiated by a triggering event or condition often referred to as a transition. Accordingly, a particular state engine is defined by a list of its states, its initial state, and the triggering condition for each transition.

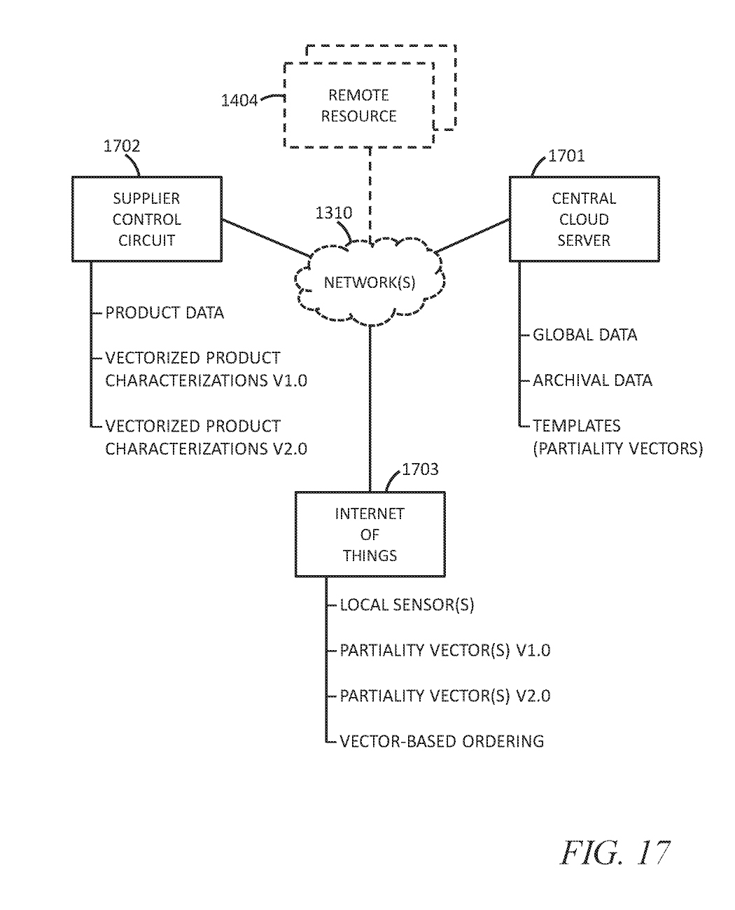

It will be appreciated that the apparatus 1300 described above can be viewed as a literal physical architecture or, if desired, as a logical construct. For example, these teachings can be enabled and operated in a highly centralized manner (as might be suggested when viewing that apparatus 1300 as a physical construct) or, conversely, can be enabled and operated in a highly decentralized manner. FIG. 17 provides an example as regards the latter.

In this illustrative example a central cloud server 1701, a supplier control circuit 1702, and the aforementioned Internet of Things 1703 communicate via the aforementioned network 1310.

The central cloud server 1701 can receive, store, and/or provide various kinds of global data (including, for example, general demographic information regarding people and places, profile information for individuals, product descriptions and reviews, and so forth), various kinds of archival data (including, for example, historical information regarding the aforementioned demographic and profile information and/or product descriptions and reviews), and partiality vector templates as described herein that can serve as starting point general characterizations for particular individuals as regards their partialities. Such information may constitute a public resource and/or a privately-curated and accessed resource as desired. (It will also be understood that there may be more than one such central cloud server 1701 that store identical, overlapping, or wholly distinct content.)

The supplier control circuit 1702 can comprise a resource that is owned and/or operated on behalf of the suppliers of one or more products (including but not limited to manufacturers, wholesalers, retailers, and even resellers of previously-owned products). This resource can receive, process and/or analyze, store, and/or provide various kinds of information. Examples include but are not limited to product data such as marketing and packaging content (including textual materials, still images, and audio-video content), operators and installers manuals, recall information, professional and non-professional reviews, and so forth.

Another example comprises vectorized product characterizations as described herein. More particularly, the stored and/or available information can include both prior vectorized product characterizations (denoted in FIG. 17 by the expression “vectorized product characterizations V1.0”) for a given product as well as subsequent, updated vectorized product characterizations (denoted in FIG. 17 by the expression “vectorized product characterizations V2.0”) for the same product. Such modifications may have been made by the supplier control circuit 1702 itself or may have been made in conjunction with or wholly by an external resource as desired.

The Internet of Things 1703 can comprise any of a variety of devices and components that may include local sensors that can provide information regarding a corresponding user's circumstances, behaviors, and reactions back to, for example, the aforementioned central cloud server 1701 and the supplier control circuit 1702 to facilitate the development of corresponding partiality vectors for that corresponding user. Again, however, these teachings will also support a decentralized approach. In many cases devices that are fairly considered to be members of the Internet of Things 1703 constitute network edge elements (i.e., network elements deployed at the edge of a network). In some case the network edge element is configured to be personally carried by the person when operating in a deployed state. Examples include but are not limited to so-called smart phones, smart watches, fitness monitors that are worn on the body, and so forth. In other cases, the network edge element may be configured to not be personally carried by the person when operating in a deployed state. This can occur when, for example, the network edge element is too large and/or too heavy to be reasonably carried by an ordinary average person. This can also occur when, for example, the network edge element has operating requirements ill-suited to the mobile environment that typifies the average person.

For example, a so-called smart phone can itself include a suite of partiality vectors for a corresponding user (i.e., a person that is associated with the smart phone which itself serves as a network edge element) and employ those partiality vectors to facilitate vector-based ordering (either automated or to supplement the ordering being undertaken by the user) as is otherwise described herein. In that case, the smart phone can obtain corresponding vectorized product characterizations from a remote resource such as, for example, the aforementioned supplier control circuit 1702 and use that information in conjunction with local partiality vector information to facilitate the vector-based ordering.

Also, if desired, the smart phone in this example can itself modify and update partiality vectors for the corresponding user. To illustrate this idea in FIG. 17, this device can utilize, for example, information gained at least in part from local sensors to update a locally-stored partiality vector (represented in FIG. 17 by the expression “partiality vector V1.0”) to obtain an updated locally-stored partiality vector (represented in FIG. 17 by the expression “partiality vector V2.0”). Using this approach, a user's partiality vectors can be locally stored and utilized. Such an approach may better comport with a particular user's privacy concerns.

It will be understood that the smart phone employed in the immediate example is intended to serve in an illustrative capacity and is not intended to suggest any particular limitations in these regards. In fact, any of a wide variety of Internet of Things devices/components could be readily configured in the same regards. As one simple example in these regards, a computationally-capable networked refrigerator could be configured to order appropriate perishable items for a corresponding user as a function of that user's partialities.

Presuming a decentralized approach, these teachings will accommodate any of a variety of other remote resources 1704. These remote resources 1704 can, in turn, provide static or dynamic information and/or interaction opportunities or analytical capabilities that can be called upon by any of the above-described network elements. Examples include but are not limited to voice recognition, pattern and image recognition, facial recognition, statistical analysis, computational resources, encryption and decryption services, fraud and misrepresentation detection and prevention services, digital currency support, and so forth.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

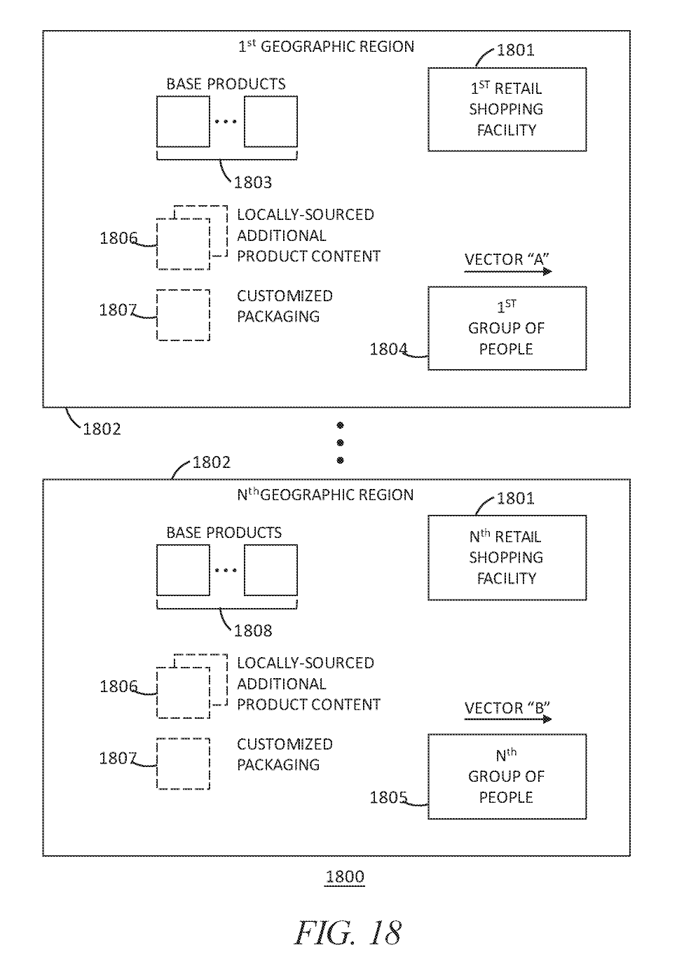

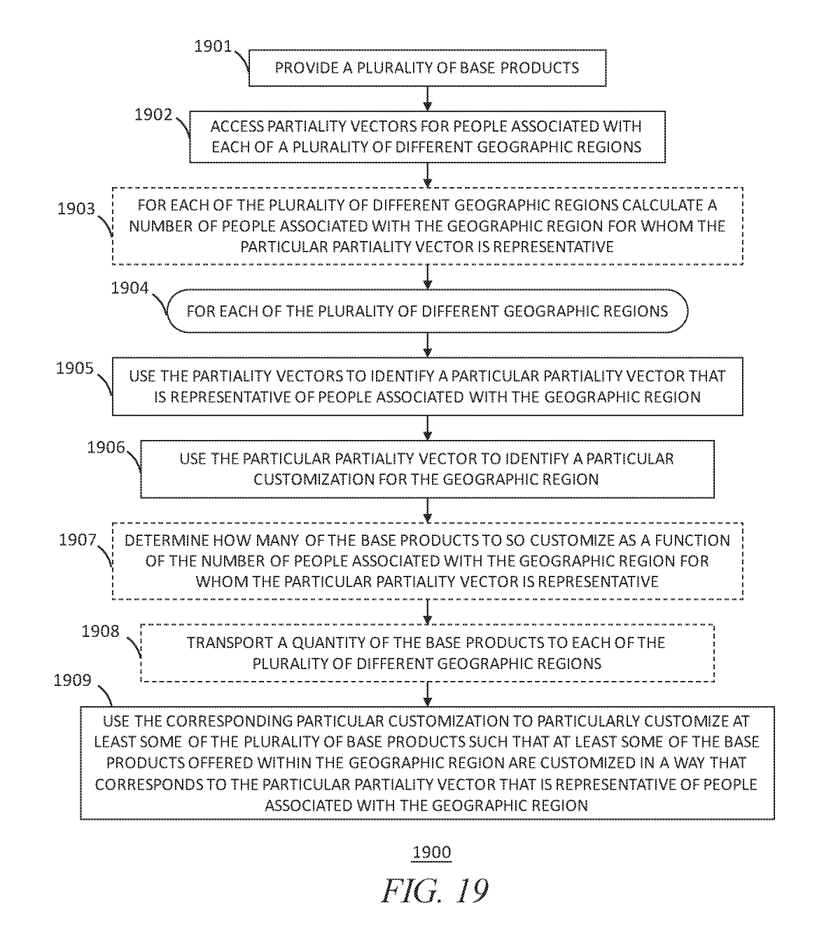

Referring now to FIGS. 18 and 19, some related approaches to leveraging such partiality vectors will be described, with FIG. 18 presenting an enabling apparatus 1800 and FIG. 19 presenting a corresponding process 1900.

The apparatus 1800 includes a plurality of retail shopping facilities 1801 represented here by a first retail shopping facility through an Nth retail shopping facility (where “N” represent an integer greater than 1). In this example each retail shopping facility 1801 comprises a retail sales facility or any other type of bricks-and-mortar (i.e., physical) facility in which products are physically displayed and offered for sale to customers who physically visit the facility. The shopping facility may include one or more of sales floor areas, checkout locations (i.e., point of sale (POS) locations), customer service areas other than checkout locations (such as service areas to handle returns), parking locations, entrance and exit areas, stock room areas, stock receiving areas, hallway areas, common areas shared by merchants, and so on. The facility may be any size or format of facility, and may include products from one or more merchants. That said, for the sake of an illustrative example it will be presumed here that all of the retail shopping facilities 1801 are operated by a same enterprise (either directly or indirectly).

In this example, each of the retail shopping facilities 1801 is located in a different geographic region 1802 (represented here by a first geographic region through an Nth geographic region). These teachings are relatively flexible in these regards. By one approach, for example, each geographic region 1802 comprises an area within a predetermined distance of the corresponding retail shopping facility 1801. For example, each geographic region 1802 may comprise a circle having a predetermined diameter (such as, for example, 0.5 miles, 1.0 miles, 5.0 miles, or the like) and having the corresponding retail shopping facility 1801 at the center thereof. By another approach, in lieu of the foregoing or in combination therewith, each geographic region 1802 may comprise an area bounded by political borders (such as the boundaries of a village, town, city, or other municipality).

That said, there is no special requirement that the geographic regions 1802 all have an identical size and/or shape or even that two or more of the geographic regions 1802 cannot overlap with one another. Again, these teachings are quite flexible in practice and will accommodate numerous variations with success.

As provided at block 1901 of the illustrated process 1900 and as shown in FIG. 19, a plurality of base products 1803 are disposed at each of the plurality of retail shopping facilities 1801. While the number of base products 1803 provided at each retail shopping facility 1801 may vary, the base products 1803 themselves are the same from one region/facility to the next.

Generally speaking (but not necessarily) the base products 1803 are the result of mass manufacturing practices and may all have been sourced by one or only a very few manufacturing facilities. These teachings will accommodate essentially any item as a base product 1803, including but not limited to food items, clothing, health and beauty items, pet supplies, home improvement items, housewares, cooking utensils, appliances, yard supplies, decorating and hobby supplies and materials, office supplies, home entertainment items, sporting goods, automotive items, toys and games, cleaning supplies and equipment, paper goods, gift items, and so forth. (That said, it will be understood that as used herein this reference to “base products” does not include pure software offerings such as video games, music, movies, and applications (such as word processing programs and so forth) whether sold in conjunction with a corresponding physical memory or downloaded via an intervening network.) While some of these base products 1803 may be offered for retail sale at one of the retail shopping facilities 1801 in an as-is form, most if not all of these base products 1803 are likely to be customized pursuant to the described process 1900.

At block 1902 this process 1900 provides for accessing (via, for example, the above-described control circuit 1301), partiality vectors 1307 for people associated with each of the plurality of different geographic regions 1802. This can comprise, for example, accessing partiality vectors 1307 for a first group of people 1804 that are associated with the first geographic region 1802 and so forth through accessing partiality vectors 1307 for an Nth group of people 1805 that are associated with the Nth geographic region 1802. A person may be “associated” with a specific geographic region 1802, for example, by residing within that region 1802 and/or by being fully employed at an enterprise that is located within that region 1802. Other valid ways of being associated are possible.

There are numerous ways by which the persons that are associated with a given geographic area can be identified. Census data, surveys, and other publicly-available and/or privately-developed information can serve in these regards. The control circuit 1301 can use that identifying information, in turn, to access the previously-determined partiality vectors 1307 that were previously developed and stored for such persons as described above.

At optional block 1903 these teachings will also provide, if desired, for calculating the number of people that are associated with geographic region 1802 for whom a particular partiality vector 1307 is representative. This activity can comprise selecting only a single partiality vector and determining how many people have at least a requisite magnitude vector in those regards or, if desired, these teachings will accommodate determining such numbers for each of a plurality of partiality vectors 1307.

As indicated at block 1904, the remaining actions are all carried out for each of the aforementioned different geographic regions 1802.

With continued reference to both FIGS. 18 and 19, at block 1905 this process 1900 provides for using the partiality vectors 1307 to identify a particular partiality vector that is representative of people associated with each of the geographic regions 1802 of interest. This action can comprise, for example, identifying a group of regionalized people having at least a minimum number of members (such as one hundred members, one thousand members, or the like) who share a same partiality vector having at least a minimum magnitude. That approach is likely in many application settings to result in identifying a number of different groups of people for a single geographic area 1802 where each group corresponds to a different partiality vector.

This action can comprise not only identifying a partiality vector having a shared “partiality” but also a partiality vector having a representative magnitude for that particular partiality. This process 1900 will accommodate various approaches in these regards. By one approach, the representative partiality vector has the aforementioned minimum magnitude that serves as a comparison guide as per the foregoing. By another approach the representative partiality vector has a magnitude that is an average or median of all the qualifying partiality vectors. Other approaches are also possible.

If desired, this activity can comprise using the partiality vectors 1307 to identify two or more partiality vectors that, in combination, are representative of people associated with each geographic region 1802. In this case different minimum magnitudes for each partiality vector 1307 can be employed or a same identical minimum magnitude can serve as desired.

By one approach the foregoing action can serve to attempt to identify one or more partiality vectors 1307 that represent at least a majority of the people associated with each geographic region 1802. In many cases, however, these teachings can be powerfully applied when identifying partiality vectors that represent groups of people who represent less than a majority of all people in a given geographic area 1802. As one simple example, while a given geographic region 1802 may have, say, ten thousand people, the present teachings may be beneficially applied with respect to a sub-group of people with, say, only one hundred members.

One relevant factor that may be useful here is the particular partiality vector 1307 that identifies a relatively small group of people. For example, a partiality vector 1307 that is relatively orthogonal to, say, mainstream partialities but that is also a very strongly held partiality by that smaller group of people may represent a very valid partiality vector for these purposes.

For the sake of an illustrative example and as shown in FIG. 18, a partiality vector denoted as “Vector A” has been so identified for the first group of people 1804 who are associated with the first geographic region 1802 while a different partiality vector denoted as “Vector B” has been so identified for the Nth group of people 1805 who are associated with the Nth geographic region 1802. It should be noted that although these identified partiality vectors happen to be different from one another in this illustrative example, there is no inherent requirement that such be the case. Instead, these teachings will readily accommodate having two or even all of the partiality vectors that are identified per the above be identical. It will be useful to remember, however, that even though the partiality vectors for multiple regions may represent the same partiality, these teachings will also accommodate permitting the partiality vectors to nevertheless have differing magnitudes.

At block 1906 this process 1900 then provides for using the identified partiality vector(s) to identify a particular customization for each of the geographic regions 1802 (i.e., a particular customization that can be applied or otherwise used with the aforementioned base product 1803). As one simple example in these regards, the particular customization can comprise locally-sourced additional product content 1806 that can be added to the base product 1803 to thereby form a composite product (where, for example, the product is “composite” by virtue of shared packaging and/or where the additional content completes an otherwise incomplete offering).

This action can comprise, for example, comparing product vectors 1304 as described above that pertain to customization options with the identified partiality vectors (such as Vector A and Vector B) to identify the customization options that best (or at least strongly) accord with the identified partiality vector(s).

At optional block 1907 the control circuit 1301 can calculate the number of people who comprise the relevant regionalized group of people for each geographic region 1802. This calculation activity can literally comprise conducting mathematical operations to derive that number or, less literally, accessing that number as previously compiled or determined.

Optional block 1908 provides for transporting a quantity of the base products 1803 to each of the geographic regions 1802. For example, all of the base products 1803 for a given area may be delivered to a corresponding one of the retail shopping facilities 1801. As another example, some or all of the base products 1803 for a given area may be delivered to a third party enterprise for appropriate handling/packaging prior to delivering the customized base products 1803 to the relevant retail shopping facility 1801. By one approach the number of base products 1803 transported to a given geographic region 1802 varies as a function of the aforementioned number of people who comprise the relevant group of people in that particular region.

In any event, at block 1909 this process 1900 provides for using the aforementioned identified particular customizations to particularly customize at least some of the base products 1803. Accordingly, at least some of the base products 1803 that are offered within a given geographic region 1802 are customized in a way that corresponds to a particular partiality vector that is representative of a group of people that is itself associated with the given geographic region 1802.

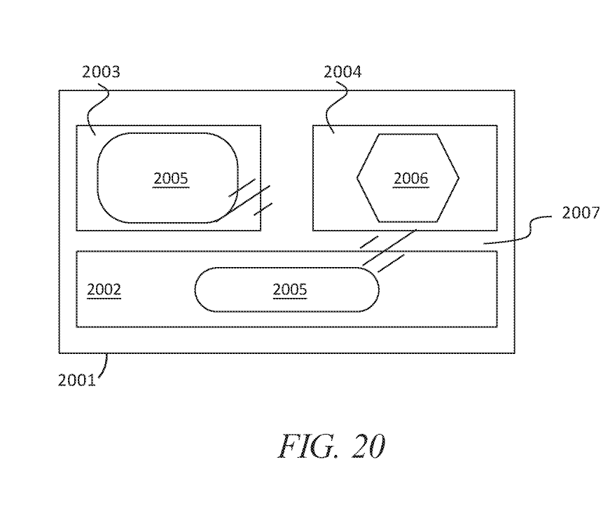

FIG. 20 provides one illustrative example in these regards. In this example the original base product comprises a plastic tray 2001 having three wells 2002-2004 formed therein, where two of the wells 2002 and 2003 have a food item 2005 disposed therein (and where, for example, these food items 2005 are individually packaged to preserve freshness). Presuming that the relevant partiality vector represents a partiality for locally-sourced, organically-grown produce, the third well 2004 contains customized content 2006 comprising locally-sourced, organically-grown produce content. That customized content 2006 can be added at the retail shopping facility 1801 or can be added by a third party enterprise of choice.

These teachings will also accommodate using customized packaging 1807 (as illustrated in FIG. 18) for the customized product. That customized packaging in the present example could comprise, for example, a plastic film 2007 sealed over the top of the plastic tray 2001 after addition of the local content. That plastic film 2007, in turn, can bear promotional content (not shown) to draw the customer's attention to the customized content to thereby help relevant customers to understand that the resultant composite product accords with their own relevant partialities.

As already noted above, these teachings can be readily applied with respect to a wide variety of base products and to a similarly wide variety of potential customizations. So configured, consumers receive the economic benefits of mass manufacturing while simultaneously receiving the benefits of customized products that well accord with their own partialities. Manufacturers of niche products can similarly benefit by being included within the ambit of large-scale retailers.

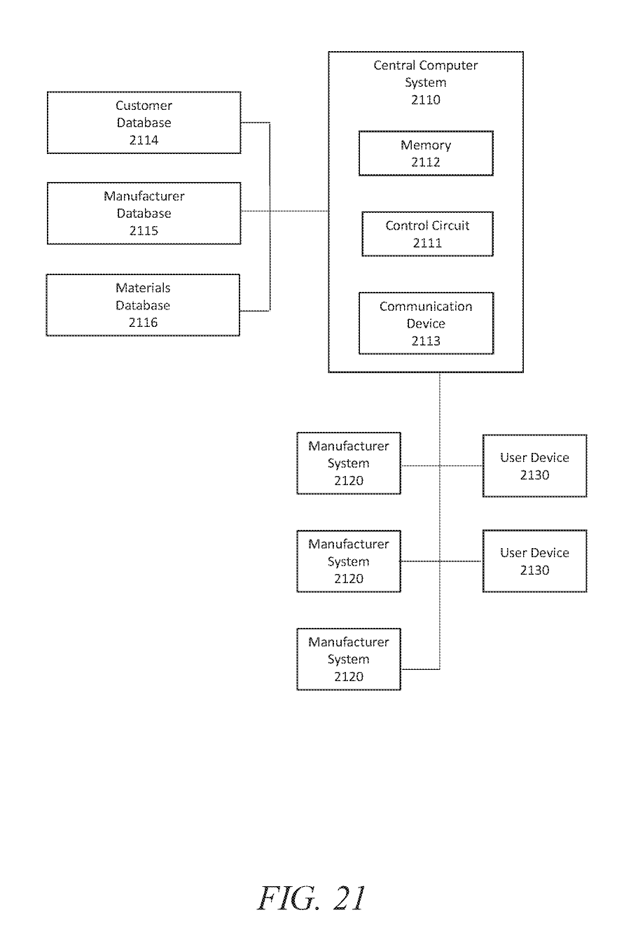

Referring next to FIG. 21, a block diagram of a system according to some embodiments is shown. The system comprises a central computer system 2110, a customer database 2114, a manufacturer database 2115, a materials database 2116, a plurality of manufacturer systems 2120, and a plurality of user devices 2130.

The central computer system 2110 may comprise a processor-based system such as one or more of a server system, a computer system, a cloud-based server, and the like. The central computer system 2110 comprises a control circuit 2111 (which may be the same as the aforementioned control circuit 1301), a memory 1212, and a communication device 2113. The control circuit 2111 may comprise a processor, a central processor unit, a microprocessor, and the like. The memory 2112 may include one or more of a volatile and/or non-volatile computer readable memory devices. In some embodiments, the memory 2112 stores computer executable codes that cause the control circuit 2111 to provide a custom manufacturing user interface to the plurality of user devices 2130 and assist customers in selecting a manufacturer based on information stored in the customer database 2114 and the manufacturer database 12115.

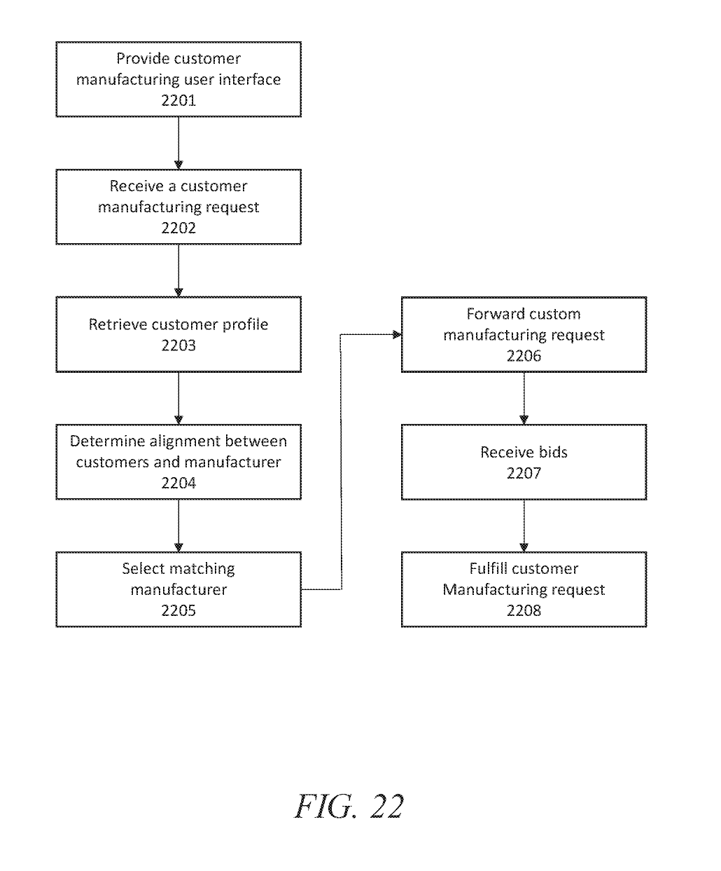

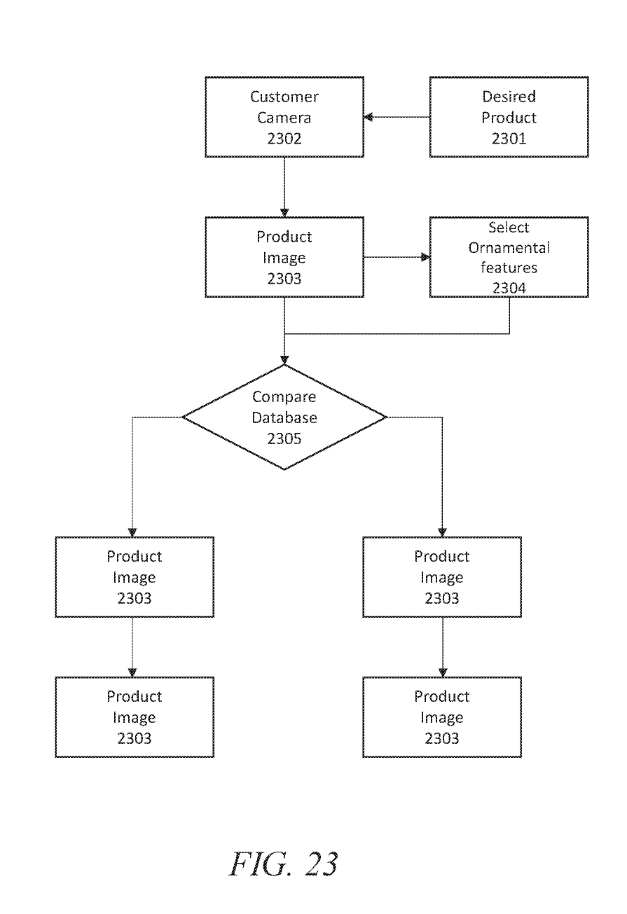

In some embodiments, the control circuit 2111 may further be configured to communicate with manufacturer systems 2120 to fulfill custom manufacturing requests for customers. In some embodiments, the control circuit 2111 may further be configured to update the customer profiles and/or vectors in the customer database 2114 based on the orders submitted and/or feedback received from the user devices 2130. In some embodiments, the computer executable code stored on the memory 2112 may cause the control circuit 2111 to perform one or more steps described with reference to FIGS. 22 and 23 herein.

The communication device 2113 may be configured to communicate with a plurality of user devices 2130 and a plurality of manufacturer systems 2120 over a network. In some embodiments, the communication device 2113 may comprise one or more of a network adapter, a data port, a network port, a modem, a router and the like. In some embodiments, the network may comprise one or more of the Internet, a public network, a private network, a secure network, a wireless data network, and the like. In some embodiments, the communication device 2113 may generally comprise one or more devices configured to allow the control circuit 2111 to exchange data with the plurality of manufacturer systems 2120 and user devices 2130. In some embodiments, the communication device may further allow the central computer system 2110 to access one or more of the customer database 2114, the manufacturer database 2115, and the materials database 2116.

The user devices 2130 may comprise electronic user interface devices configured to present custom manufacturing user interfaces to customers. In some embodiments, a user device 2130 may comprise a control circuit, a memory, and one or more user input/output devices such as a display screen, a touch screen, a microphone, a keyboard, and the like. In some embodiments, a user device 2130 may comprise one or more of a personal computer, a laptop computer, a tablet computer, a mobile device, a smartphone, a wearable device, and the like.

In some embodiments, the custom manufacturing user interface may comprise one or more of a mobile application, a desktop application, a web page, a web-based user interface, etc. In some embodiments, the custom manufacturing user interface may comprise a graphical user interface (GUI) that allows the user to configure various options of a custom manufacturing request. For example, the customer may modify the design for the product and/or select a color or a material of the custom manufactured product. In some embodiments, the custom manufacturing user interface may be configured to present the customer with a visual mockup of the requested custom manufactured product. In some embodiments, the custom manufacturing user interface may allow the customer to upload images to configure a custom manufacturing order. For example, a custom manufacturing user interface mobile application may use a smartphone's camera to allow the user to capture an image of a shoe or a design on a t-shirt to generate a custom manufacturing request.

The manufacturer systems 2120 may comprise systems associated with one or more manufacturers. In some embodiments, a manufacturer system 2120 may comprise a user interface through which manufacturers may review customer requests and submit bids for requests. In some embodiments, a manufacturer system 2120 may comprise a control circuit, a memory, and one or more user input/output devices such as a display screen, a touch screen, a microphone, a keyboard, and the like. In some embodiments, a manufacturer system 2120 may comprise one or more of a personal computer, a laptop computer, a tablet computer, a mobile device, a smartphone, a wearable device, and the like. In some embodiments, the central computer system 2110 may provide a manufacturer user interface to the manufacturer systems 2120. In some embodiments, the manufacturer user interface may comprise one or more of a mobile application, a desktop application, a web page, a web-based user interface, etc. In some embodiments, the manufacturer user interface may comprise a graphical user interface (GUI) that allows manufacturers to review custom manufacturing request and submit bids for the requests. In some embodiments, one or more manufacturer systems 2120 may be configured to automatically respond to manufacturing requests without further user input. For example, the manufacturing system may comprise a set of rules to determine whether a custom manufacturing request can be completed and/or to determine the cost for the custom manufacturing request.

The central computer system 2110 may be coupled to a customer database 2114, a manufacturer database 2115, and/or a materials database 2116 via one or more wired and/or wireless communication channels. The customer database 2114 may be configured store customer profiles for a plurality of customers. Each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors. In some embodiments, customer value vectors each comprises a magnitude that corresponds to the customer's belief in the good that comes from an order associated with that value.

In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer feedback to manufacturers, etc. In some embodiments, customer vectors determined from a customer's purchase history and comments associated with one or more product categories may be used to match the customer to a product or manufacturer in a category from which the customer has not previously made a purchase. For example, customer vectors determined from the customer's purchase of snacks and pet foods may indicate that the user values natural products. The customer vector and magnitude associated with natural products may then be used to match the user to products and/or manufacturers in the beauty and personal care categories.

The manufacturer database 2115 may store information on one or more manufacturers registered with the central computer system 2110. In some embodiments, manufacturer characteristics stored in the manufacturer database 2115 may comprise one or more of manufacturer name, manufacturer location(s), manufacturer capability, manufacturer reputation, manufacturer customer review, material sourcing information, manufacturer compliance record, manufacturer certification, and manufacturer vectors.

In some embodiments, the manufacturer profiles may associate vectorized manufacturer characterizations with the manufacturers. In some embodiments, the vectorized manufacturer characterizations may comprise one or more vectors associated with customer values, preferences, affinities, and/or aspirations in reference to the manufacturers and/or products produced by the manufacturers. For example, a manufacturer profile may comprise vectorized product value characterization that includes a magnitude that corresponds to how well the manufacturer's practices align with a customer's cruelty-free value vector. In some embodiments, the manufacturer characteristics and/or vectors may be determined based on one or more of manufacturer supplied information, products and materials offered by the manufacturer, customer feedback, public record, manufacturer certification record, manufacturer location, third party organization rating/certification (e.g. PETA, Greenpeace), etc.

In some embodiments, the system may further include a materials database 2116 storing characteristics associated with manufacturing materials used by manufacturers to manufacture products for customers. In some embodiments, manufacturing materials may comprise one or more of: 3D printing powder, 3D printing filament, decorative elements (e.g. apparel add-on, decorative decal, embossing thread, printer ink, etc.), base items configured to be modified (e.g. plain t-shirt, plain mailbox, blank card stock, plain cell phone case, etc.), alteration materials (e.g. tailoring thread, trimmer), parts of an item (e.g. furniture parts, machine parts, toy parts, etc.), plants (e.g. tomato plant, mushroom farm, herbs, etc.), etc. In some embodiments, characteristics of the materials may be determined based on one or more of material origin, material description, material ingredients, material specification, brand reputation, and customer feedback.

In some embodiments, the material characteristic may comprise vectorized material characterizations associated with the different manufacturing materials. In some embodiments, the vectorized material characterizations may comprise one or more vectors associated with customer values, preferences, affinities, and/or aspirations in reference to the products. For example, a manufacturing material profile may comprise vectorized material value characterization that includes a magnitude that corresponds to how well the manufacturing material aligns with a customer's environmentally-friendly value vector. In some embodiments, the central computer system 2110 and/or the manufacturer system may use the materials database to select materials for completing a custom manufacturing request.

While the customer database 2114, the manufacturer database 2115, and the materials database 2116 are shown to be outside the central computer system 2110 in FIG. 21, in some embodiments, the customer database 2114, the manufacturer database 2115, and/or the materials database 2116 may be implemented as part of the central computer system 2110 and/or the memory 2112 local to the central computer system 2110. In some embodiments, the customer database 2114, the manufacturer database 2115, and/or the materials database 2116 may comprise one or more server-based and/or cloud-based storage databases accessible by the central computer system 2110, the user device 2130, and/or the manufacturer system 2120 through network connections. In some embodiments, the customer database 2114, the manufacturer database 2115, and the materials database 2116 comprise database structures that represent customer values, manufacturer characteristics, and material characteristics, respectively, in vector form.

Referring next to FIG. 22, a method for providing custom manufacturing according to some embodiments is shown. The steps in FIG. 22 may generally be performed by a processor-based device such as a central computer system, a server, a cloud-based server, a customer order management system, a personal computer, a user device, etc. In some embodiments, the steps in FIG. 22 may be performed by one or more of the central computer system 2110, the user device 2130, and the manufacturer system 2120 described with reference to FIG. 21 herein, and/or other similar devices.

In step 2201, the system provides a custom manufacturing user interface to a plurality of user devices. A user device may comprise a user interface device configured to provide a custom manufacturing user interface to a customer. In some embodiments, the user device comprises a control circuit, a memory, and one or more user input/output devices such as a display screen, a touch screen, a microphone, a keyboard, and the like. In some embodiments, the user device may comprise one or more of a personal computer, a laptop computer, a tablet computer, a mobile device, a smartphone, a wearable device, and the like. In some embodiments, the custom manufacturing user interface may comprise one or more of a mobile application, a desktop application, a web page, a web-based user interface, etc. In some embodiments, the custom manufacturing user interface may comprise a graphical user interface (GUI) that allows the user to submit a custom manufacturing request and configure various options associated with the custom manufacturing request.

In step 2202, the system receives a custom manufacturing request from a user via the custom manufacturing user interface. In some embodiments, the custom manufacturing user interface may allow the customer to upload images or a 3D scan to configure a custom manufacturing order. For example, a custom manufacturing user interface mobile application may access a smartphone's camera to allow the user to capture an image of the desired product through the mobile application. In some embodiments, the custom manufacturing user interface may allow the customer to select specific features (e.g. decorative features, a portion of the item) from one or more items to include in the request. For example, the customer may select a pattern from one dress to combine with the shape of another dress. In some embodiments, the custom manufacturing user interface may allow the customer to select specific features to alter for the request. For example, the customer may add or remove handles on a mug. In some embodiments, the custom manufacturing user interface may allow the user to provide text, images, and/or video descriptions of the desired product. For example, the customer may upload an image of a porcelain figure and request, in text, that it be 3D printed in all red. In some embodiments, the custom manufacturing request may comprise other customer parameters and constraints such as production quantity, price range, completion date, etc. In some embodiments, the custom manufacturing request may comprise a request for one or more of a 3D printed object based on a photograph, a 3D printed object based on a 3D scan, a custom tailored article of clothing, a custom printed object, a food item, a furniture item, and a decorative item.

In step 2203, the system retrieves a customer profile associated with the user from the customer database. The customer database may be configured store customer profiles for a plurality of customers. In some embodiments, each customer profile may comprise one or more of customer name, customer location(s), customer demographic information, customer configured preferences, customer purchase history, and customer vectors. Customer vectors may comprise one or more of a customer value vectors, customer partiality vectors, customer preference vectors, customer affinity vectors, and customer aspiration vectors. In some embodiments, customer value vectors each comprises a magnitude that corresponds to the customer's belief in the good that comes from an order associated with that value. In some embodiments, customer vectors may each represent at least one of a person's values, preferences, affinities, and aspirations. In some embodiments, the customer value vectors each represents at least one of a person's values leading to at least one of a plurality of possible preferences and affinities and comprises a magnitude that corresponds to the customer's belief in good that comes from an order associated with that value. In some embodiments, the customer vectors may be determined and/or updated based on one or more of customer purchase history, customer survey input, customer reviews, customer item return history, customer return comments, and customer feedback to manufacturers, etc. In some embodiments, customer vectors determined from a customer's purchase history and comments associated with one or more product categories may be used to match the customer to a product or manufacturer in a category from which the customer has not previously made a purchase. For example, customer vectors determined from the customer's purchase of snacks and pet foods may indicate that the user values natural products. The customer vector and magnitude associated with natural products may then be used to match the user to products and/or manufacturers in the beauty and personal care categories.

In step 2204, the system determines the alignments between the customer profile and the manufacturer characteristics associated with the plurality of manufacturers stored in the manufacturer database. In some embodiments, manufacturer characteristics stored in the manufacturer database may comprise one or more of manufacturer name, manufacturer location(s), manufacturer capability, manufacturer reputation, material sourcing information, manufacturer compliance record, manufacturer certification, and manufacturer vectors. In some embodiments, the manufacturer profiles may associate vectorized manufacturer characterizations with the manufacturers. In some embodiments, the vectorized manufacturer characterizations may comprise one or more vectors associated with customer values, preferences, affinities, and/or aspirations in reference to the products. For example, a manufacturer profile may comprise vectorized product value characterization that includes a magnitude that corresponds to how well the manufacturer's practices align with a customer's cruelty-free value vector. In some embodiments, the manufacturer characteristics may be determined based on one or more of manufacturer supplied information, products and materials offered by the manufacturer, customer feedback, public record, manufacturer certification record, manufacturer location, third party organization rating/certification (e.g. PETA, Greenpeace) etc.

In some embodiments, the alignment may be determined by comparing the customer's values, preferences, partialities, affinities, aspirations, and/or customer inputted parameters with the characteristics of the manufacturers. For example, if a customer select to be matched with only local manufacturers, the system may determine that local manufacturers align with the customer's profile. In another example, if a customer values humane treatment of animals, the system may determine that manufacturers that are a certified to be cruelty-free have high alignments with the customer. In some embodiments, the alignment may be determined based on comparing customer value vectors with manufacturer characteristics. In some embodiments, determining alignments comprise determining match scores for the plurality of manufacturers and the matching manufacturers are selected based on the match scores for each of the plurality of manufacturers. In some embodiments, the alignment may be determined based on comparing customer value vectors with vectorized manufacturer characterizations. In some embodiments, the alignment between a manufacturer and the customer may be determined by adding, subtracting, multiplying, and/or dividing the magnitudes of the corresponding vectors in the customer vectors and vectorized manufacturer characterizations. In some embodiments, alignment scores for each associated vector may be added and/or averaged to determine an overall manufacturer alignment score. In some embodiments, the system may only consider the prominent vectors (e.g. high magnitude vectors) associated with the customer in determining manufacturer alignment. In some embodiments, manufacturers may be evaluated based on whether the manufacturers meet one of more of the customer's requirements. In some embodiments, the customer requirements may be determined based on customer inputted parameters and/or may be determined based on the customer's vectors. For example, if the customer's cruelty-free vector has a magnitude above a threshold, the system may only select manufacturers with cruelty-free certification.

In step 2205, the system selects matching manufacturers from the plurality of manufacturers based on the alignments determined in step 2204. In some embodiments, the system may select a set number of matching manufacturers with the highest matching scores, select all manufacturers meeting at least a matching score threshold, and/or select manufacturers meeting all the requirements associated with the customer. In some embodiments, the matching manufacturers may further be selected based on each manufacturer's ability to complete the custom manufacturing request. For example, the system may maintain a list of product types that each manufacturer is capable of making (e.g. t-shirts, 3D printing, carpentry, etc.), and would only match users to manufacturers with suitable capability. In some embodiments, the system may be configured to select materials for completing the custom manufacturing request based on the customer profile. For example, the system may compare customer value vectors in a customer profile with vectorized material characteristics in a materials database to determine alignments between materials and the customer. The system may then select the material(s) to be used for manufacturing the requested custom manufacturing product for the customer. In some embodiments, the matching manufacturers may be further selected based on whether the manufacturer uses the material selected for the custom manufacturing request.

In step 2206, the system forwards the custom manufacturing request to manufacturer systems associated with the matching manufacturers for bidding. The manufacturer systems may comprise systems associated with one or more manufacturers. In some embodiments, a manufacturer system may comprise a user interface through which a manufacturer may review orders and submit bids for orders. In some embodiments, a manufacturer system may comprise a control circuit, a memory, and one or more user input/output devices such as a display screen, a touch screen, a microphone, a keyboard, and the like. In some embodiments, the system may further provide a manufacturer user interface to the manufacturer systems. In some embodiments, the manufacturer user interface may comprise one or more of a mobile application, a desktop application, a web page, a web-based user interface, etc. In some embodiments, the manufacturer user interface may comprise a graphical user interface (GUI) that allows manufacturers to review custom manufacturing request and submit bids for the requests. In some embodiments, one or more manufacturer systems may be configured to automatically respond to manufacturing requests without user input. For example, the manufacturing system may comprise a set of rules to determine whether a custom manufacturing request can be completed and/or to determine the cost for the custom manufacturing order. In some embodiments, the system may be configured to select materials for completing the custom manufacturing request based on the customer profile. The system may include the selected materials in the custom manufacturing requests forwarded to the manufacturer systems. In some embodiments, the system may provide customer value vectors in the customer profile to the manufacturer. The manufacturers may select materials and/or manufacturing methods for the manufacturing request based on the customer value vectors and include the selections in the bid.

In step 2207, the system receives bids for the custom manufacturing request from the manufacturer systems. In some embodiments, the bids may comprise a price quote for fulfilling the manufacturing request. In some embodiments, the bids may comprise other specification such as turnaround time, shipping cost, materials to be used, machinery to be used, manufacturing location, contract terms, etc. In some embodiments, the system may permit each manufacturer to submit more than one bid with different specifications. For example, a manufacturer may propose to print a t-shirt with different types of fabric and submit separate bids for each fabric.

In some embodiments, after step 2207, the system may present the matching manufacturers to the user via the custom manufacturing user interface for user selection. In some embodiments, the custom manufacturing user interface may display one or more details of the bid (e.g. pricing, delivery date, etc.) and/or one or more details of the manufacturer (e.g. location, characteristics, rating, etc.). In some embodiments, the custom manufacturing user interface may display characteristics of the manufacturer that have high alignments with the customer profile to the customer. For example, if the customer values environmental friendliness, they system may highlight the manufacturer's use of sustainably sourced materials to the customer. In some embodiments, the system may rank the bids based on the manufacturer's alignment to the customer and/or the pricing of the bid. The customer may select a manufacturer from the displayed list of manufacturers to proceed to step 2208.

In some embodiments, the system may be configured to automatically select a bid from the bids received from the manufacturer systems to fulfill the custom manufacturing request. In some embodiments, the manufacturer may be selected based on prices associated with the bids. In some embodiments, the system may consider the manufacturer's alignment with the customer along with the price. For example, a highly aligned manufacturer with a slightly higher price may be selected over a manufacturer with lower price and lower alignment. In some embodiments, the system may be configured to determine a bid score based on the manufacture's alignments with the customer and details of the bid (e.g. cost, delivery date, material, etc.) and select a manufacturer based on the bid scores associated with each manufacture's bids. For example, if a highly aligned manufacturer submits a bid with a material that is not well aligned with the customer's profile, another bid with a more well-aligned material may be selected instead.

In the step 2208, the system fulfills the custom manufacturing request with a bid associated with a manufacturer selected from among the bids. In some embodiments, the system may be configured to facilitate the transaction between the customer and the manufacturer by providing a communication interface, payment processing, shipping, item logistics, etc. In some embodiments, the system may provide customer value vectors in the customer profile to the selected manufacturer. In some embodiments, the manufacturer may select manufacturing materials and/or methods based on the customer profiles. The manufacturer may then produce the custom manufacturing product(s) and deliver the product(s) to the customer to complete the transaction.

In some embodiments, after step 2208, the system may prompt the customer for feedback on the manufacturer, the manufacturing materials, and/or the custom manufactured product. The feedback may be used to update the customer's customer profile in the customer database, the manufacturer's profile in the manufacturer database, and/or the material's information in the materials database. In some embodiments, a system may simultaneously execute multiple instances of steps 2201-2208 for a plurality of customers and/or user devices.

Referring next to FIG. 23, a method for providing custom manufacturing according to some embodiments is shown. The steps in FIG. 23 may generally be performed by a processor-based device such as a central computer system, a server, a cloud-based server, a customer order management system, a personal computer, a user device, etc. In some embodiments, the steps in FIG. 23 may be performed by one or more of the central computer system 2110, the user device 2130, and the manufacturer system 2120 described with reference to FIG. 21 herein, and/or other similar devices.

The process begins with a customer using a customer camera 2302 to capture an image of a desired product 2301 to produce a product image 2303. In some embodiments, the product image 2303 may comprise a photograph, a video, and/or a 3D scan of an object. In some embodiments, the customer may optionally select ornamental features in the product image in step 2304 to include in the custom manufacturing request. In step 2305, the system compares the product image 2303 with a database of known products.

When there is a match, the process proceeds to step 2311 and the system sends an order to the manufacturer of the matching product. In some embodiments, the system may also provide the customer's vectors to the manufacturer and in step 2312, the manufacturer may customize the product based on customer vectors. When there no match found in step 2305, the process proceeds to step 2321 and the system prints a 3D prototype of the product based on the product image 2303. In some embodiments, the system may instead determine one or more characteristics associated with the product (e.g. product category, product material, associated manufacturing machinery, etc.) based on the product image 2303.

In step 2322, the system selects the closest matching manufacturer to produce the requested product. In some embodiments, the closest matching manufacturer may comprise a crowd-sourced manufacturing service. For example, the request may be forwarded to members of a crowd-sourced custom manufacturing platform. Members with manufacturing capabilities may then bid for the project.

In some embodiments, the system and methods described herein may provide mass custom manufacturing from customer photographs or scans. In some embodiments, the system may use photographs or scans from customers to custom manufactured products. The system may allow a customer to have a product custom manufactured by using one or more of photographs of existing products (e.g. a phone case with a specific logo or color or finish), a shoe with the heel from another shoe, a sneaker with alternate colors, fasteners or sole, 3D body scan for custom sizing garments and shoes, etc. In some embodiments, the system may function as a reverse product selling platform where the customer uploads the photographs and is provided bids for providing the custom manufacturing works. In some embodiments, a customer may order personalized products using photographs and/or order personalized clothes using 3D scans.

In some embodiments, a system for providing custom manufacturing comprises a communication device configured to communicate with a plurality of user devices and a plurality of manufacturer systems over a network. a customer database storing customer profiles associated with a plurality of customers, a manufacturer database storing manufacturer characteristics associated with a plurality of manufacturers, and a control circuit coupled to the communication device, the customer database, and the manufacturer database, the control circuit being configured to: provide a custom manufacturing user interface to the plurality of user devices, receive a custom manufacturing request from a user via the custom manufacturing user interface, retrieve a customer profile associated with the user from the customer database, determine alignments between the customer profile and the manufacturer characteristics associated with the plurality of manufacturers stored in the manufacturer database, select matching manufacturers from the plurality of manufacturers based on the alignments, forward the custom manufacturing request to manufacturer systems associated with the matching manufacturers for bidding, receive bids for the custom manufacturing request from the manufacturer systems, and fulfill the custom manufacturing request with a bid associated with a manufacturer selected from among the bids.

In one embodiment, a method for providing custom manufacturing comprises providing, via a communication device configured to communicate with a plurality of user devices and a plurality of manufacturer systems over a network, a custom manufacturing user interface to the plurality of user devices, receiving, at a control circuit coupled to the communication device, a custom manufacturing request from a user via the custom manufacturing user interface. retrieving a customer profile associated with the user from a customer database storing customer profiles associated with a plurality of customers, determining alignments between the customer profile associated with the user and manufacturer characteristics associated with a plurality of manufacturers stored in a manufacturer database, selecting, with the control circuit, matching manufacturers from the plurality of manufacturers based on the alignments, forwarding the custom manufacturing request to manufacturer systems associated with the matching manufacturers for bidding, receiving, at the control circuit, bids for the custom manufacturing request from the manufacturer systems, and fulfilling the custom manufacturing request with a bid associated with a manufacturer selected from among the bids.

In one embodiment, an apparatus for providing custom manufacturing, comprises a non-transitory storage medium storing a set of computer readable instructions and a control circuit configured to execute the set of computer readable instructions which causes to the control circuit to: provide, via a communication device configured to communicate with a plurality of user devices and a plurality of manufacturer systems over a network, a custom manufacturing user interface to the plurality of user devices, receive a custom manufacturing request from a user via the custom manufacturing user interface, retrieve a customer profile associated with the user from a customer database storing customer profiles associated with a plurality of customers, determine alignments between the customer profile associated with the user and manufacturer characteristics associated with a plurality of manufacturers stored in a manufacturer database, select matching manufacturers from the plurality of manufacturers based on the alignments, forward the custom manufacturing request to manufacturer systems associated with the matching manufacturers for bidding, receive bids for the custom manufacturing request from the manufacturer systems, and fulfill the custom manufacturing request with a bid associated with a manufacturer selected from among the bids.

As already suggested above, these approaches provide powerful ways for identifying products and/or services that a given person, or a given group of persons, may likely wish to buy to the exclusion of other options. When the magnitude and direction of the relevant/required meta-force vector that comes from the perceived effort to impose order is known, these teachings will facilitate, for example, engineering a product or service containing potential energy in the precise ordering direction to provide a total reduction of effort. Since people generally take the path of least effort (consistent with their partialities) they will typically accept such a solution.

As one simple illustrative example, a person who exhibits a partiality for food products that emphasize health, natural ingredients, and a concern to minimize sugars and fats may be presumed to have a similar partiality for pet foods because such partialities may be based on a value system that extends beyond themselves to other living creatures within their sphere of concern. If other data is available to indicate that this person in fact has, for example, two pet dogs, these partialities can be used to identify dog food products having well-aligned vectors in these same regards. This person could then be solicited to purchase such dog food products using any of a variety of solicitation approaches (including but not limited to general informational advertisements, discount coupons or rebate offers, sales calls, free samples, and so forth).

As another simple example, the approaches described herein can be used to filter out products/services that are not likely to accord well with a given person's partiality vectors. In particular, rather than emphasizing one particular product over another, a given person can be presented with a group of products that are available to purchase where all of the vectors for the presented products align to at least some predetermined degree of alignment/accord and where products that do not meet this criterion are simply not presented.

And as yet another simple example, a particular person may have a strong partiality towards both cleanliness and orderliness. The strength of this partiality might be measured in part, for example, by the physical effort they exert by consistently and promptly cleaning their kitchen following meal preparation activities. If this person were looking for lawn care services, their partiality vector(s) in these regards could be used to identify lawn care services who make representations and/or who have a trustworthy reputation or record for doing a good job of cleaning up the debris that results when mowing a lawn. This person, in turn, will likely appreciate the reduced effort on their part required to locate such a service that can meaningfully contribute to their desired order.

These teachings can be leveraged in any number of other useful ways. As one example in these regards, various sensors and other inputs can serve to provide automatic updates regarding the events of a given person's day. By one approach, at least some of this information can serve to help inform the development of the aforementioned partiality vectors for such a person. At the same time, such information can help to build a view of a normal day for this particular person. That baseline information can then help detect when this person's day is going experientially awry (i.e., when their desired “order” is off track). Upon detecting such circumstances these teachings will accommodate employing the partiality and product vectors for such a person to help make suggestions (for example, for particular products or services) to help correct the day's order and/or to even effect automatically-engaged actions to correct the person's experienced order.

When this person's partiality (or relevant partialities) are based upon a particular aspiration, restoring (or otherwise contributing to) order to their situation could include, for example, identifying the order that would be needed for this person to achieve that aspiration. Upon detecting, (for example, based upon purchases, social media, or other relevant inputs) that this person is aspirating to be a gourmet chef, these teachings can provide for plotting a solution that would begin providing/offering additional products/services that would help this person move along a path of increasing how they order their lives towards being a gourmet chef.

By one approach, these teachings will accommodate presenting the consumer with choices that correspond to solutions that are intended and serve to test the true conviction of the consumer as to a particular aspiration. The reaction of the consumer to such test solutions can then further inform the system as to the confidence level that this consumer holds a particular aspiration with some genuine conviction. In particular, and as one example, that confidence can in turn influence the degree and/or direction of the consumer value vector(s) in the direction of that confirmed aspiration.

All the above approaches are informed by the constraints the value space places on individuals so that they follow the path of least perceived effort to order their lives to accord with their values which results in partialities. People generally order their lives consistently unless and until their belief system is acted upon by the force of a new trusted value proposition. The present teachings are uniquely able to identify, quantify, and leverage the many aspects that collectively inform and define such belief systems.

A person's preferences can emerge from a perception that a product or service removes effort to order their lives according to their values. The present teachings acknowledge and even leverage that it is possible to have a preference for a product or service that a person has never heard of before in that, as soon as the person perceives how it will make their lives easier they will prefer it. Most predictive analytics that use preferences are trying to predict a decision the customer is likely to make. The present teachings are directed to calculating a reduced effort solution that can/will inherently and innately be something to which the person is partial.

These teachings can be leveraged and utilized in still other ways as well. Consider a household where a wife prepares meals for her husband. The wife has knowledge of the items that her husband likes to eat as well as his values such as eating healthy, having an exciting taste profile, a preference for comfort foods, or a desire for organic foods to mention a few examples. The husband's values can be represented as customer partiality (value) vectors. When the wife chooses a recipe, she is aligning her decision around the husband's values. She is not trying to predict the meal preference of the husband on any given day.

To take one example, the husband might have a preference on a given day for Chinese food, but his wife has prepared Mexican food. When he gets home, his preference will change when he smells, sees, and hears the food preparation. Even if his preference for a particular type of meal or cuisine changes, his values remain the same. His wife is confident that he will choose to eat what she has prepared because she knows that it will be healthy, has an exciting taste profile and communicates a feeling of comfort. In other words, the value proposition of the product (the meal) is aligned with the values of the customer (the husband's values).

As the husband's value of eating healthy trends stronger, the recipe choices will move in that direction. For example, the wife may purchase a very expensive healthy ingredient that a recipe calls for and which the husband might still choose to eat, but he may decide that the meal was not good enough to justify the cost. The wife then knows that at this time, the trending value of eating healthy is not strong enough to overcome the high cost of the ingredients. The wife is constantly adjusting the alignment of the value proposition of a recipe against her husband's culinary values to provide the best recipe selection that her husband will always prefer.

Applying this example across multiple customers, (1) if the values of customers (represented by customer partiality vectors) are known, (2) if a trending value for multiple customers is determined from an aggregate of the customer partiality vectors, and (3) if the product's value proposition (represented by the vectorized product characterizations) is also known, then an alignment between the trending values and the value proposition can be maximized. More specifically, an alignment between the two vector quantities (i.e., the trending values and vectorized product characterizations) can be maximized or achieved such that when a customer perceives that the alignment is satisfactory, the customer will select or purchase the product.

With these examples in mind and in some of these embodiments, a system that is configured to maximize certainty for customer purchases of a product from a manufacturer includes a receiver circuit, a communication network, a database, and a control circuit. The receiver circuit is disposed at a manufacturer of products and the communication network is coupled to the receiver circuit.

The database includes a plurality of customer partiality vectors. Each of the customer partiality vectors comprises a customer preference that is programmatically linked to a strength of the customer preference. The database also includes a plurality of vectorized product characterization. Each of the vectorized product characterizations comprise a product characteristic associated with a product produced by the manufacturer that is programmatically linked to a strength of the product characterization.

The control circuit is coupled to the database and the communication network, and disposed at a central processing center. The control circuit is configured to, based upon an analysis of strengths of the customer preferences for selected ones of the customer partiality vectors, determine one or more trending values. The control circuit is configured to, based on the trending value, transmit a recommendation message to the receiver circuit at the manufacturer identifying a modification to the product or the creation of a new product. The modification of the product or the creation of the new product, when made by the manufacturer, is effective to increase an alignment between the one or more vectorized product characterizations and the trending values. The increased alignment is effective to maximize customer purchases of the product or the new product.

In aspects, the product modification is effective to adjust a strength of one of the vectorized product characterizations of the existing product. In other aspects, the trending value is the customer preference having the greatest change over a predetermined time period amongst the customer partiality vectors. In still other aspects, the trending value is the customer preference having the greatest strength amongst the customer partiality vectors.

In some examples, the recommendation message specifies an adjustment to the sourcing of parts of the product. In still other examples, the recommendation message specifies an adjustment to the advertising or marketing for the product. In yet other examples, the recommendation message specifies an adjustment be made to the physical characteristics of the product.

In some examples, the customer preference relates to a color, size, weight, source, price, or associated promotion associated with the product. In other examples, the product characteristic relates to a color, size, weight, source, price, or associated promotion associated with the product.

In some aspects, the control circuit is configured to select a subset of the customer partiality vectors. For example, partiality vectors of customers living in certain geographic area can be selected.

In others of these embodiments, at a central processing center, a plurality of customer partiality vectors is received from a database. Each of the customer partiality vectors comprises a customer preference of a customer that is programmatically linked to a strength of the customer preference.

At the central processing center, a plurality of vectorized product characterizations is received from the database. Each of the vectorized product characterizations comprises a product characteristic programmatically linked to a strength of the product characteristic.

Based upon an analysis of strengths of the customer preferences for selected ones of the customer partiality vectors and at the central processing center, one or more trending values is determined. At the central processing center and based on the trending value, a recommendation message is formed and transmitted to the receiver circuit identifying a product modification to a product or the creation of a new product. The product modification or the creation of the new product, when made by the manufacturer, is effective to increase an alignment between at least one of the vectorized product characterizations and the trending values such that the increased alignment is effective to maximize customer purchases of the existing product.

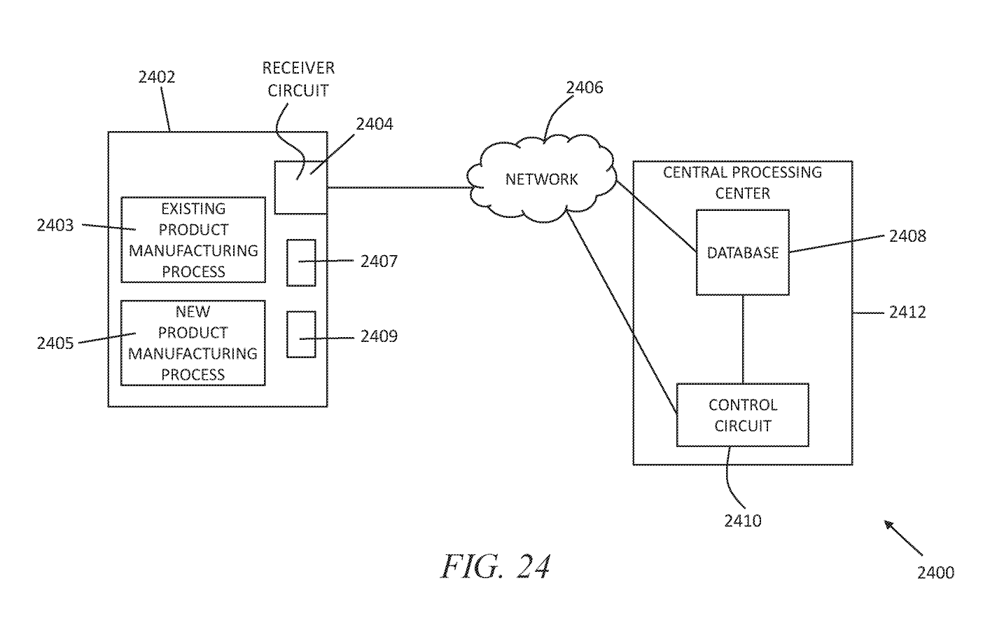

Referring now to FIG. 24, one example of a system 2400 that is configured to maximize customer purchases of a product at a manufacturer (or supplier) 2402 includes a receiver circuit 2404, a communication network 2406, a database 2408, and a control circuit 2410. The receiver circuit 2404 is disposed at a manufacturer 2402 and the communication network 2406 is coupled to the receiver circuit 2404. It will be appreciated that many of the examples described relate to physical products, that these examples also apply to services provided (e.g., actions, work, help, aid, or assistance).

The manufacturer 2402 may be any type of manufacturer or supplier, for example, a manufacturer of electronics, consumer products, automobiles, food products, or medical products to mention a few examples. The manufacturer 2402 may be a factory that includes industrial machines, assembly lines, industrial processes, and supplies to mention a few examples. The receiver circuit 2404 may be any combination of hardware or software elements that receive information from the communication network 2406. In some examples, the receiver circuit 2406 may be replaced with a transceiver circuit, which is configured to both transmit and receive information from/to the communication network 2406.

The communication network 2406 is any type of communication network. In examples, the communication network may be the cloud network, or the Internet. The communications network 2406 may include routers, gateways, and servers to mention a few examples of devices that can form or be utilized in the network 2406. The communication network 2406 may also be combinations of various types of networks.

The database 2408 includes a plurality of customer partiality vectors. Each of the customer partiality vectors comprises a customer preference for a customer that is programmatically linked to a strength of the customer preference. The database 2408 also includes a plurality of vectorized product characterizations. Each of the vectorized product characterizations comprises a product characteristic that is programmatically linked to a strength of the product characteristic.

The control circuit 2410 is coupled to the database and the communication network, and disposed at a central processing center 2412. The database 2408 may also be disposed at the central processing center 2412, but, in aspects, may be disposed at a different location.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 2410 may be configured (for example, by using corresponding programming stored in a memory as will be well understood by those skilled in the art) to carry out one or more of the steps, actions, and/or functions described herein.

The control circuit 2410 is configured to, based upon an analysis of strengths of the customer preferences for selected ones of the customer partiality vectors, determine one or more trending values. The control circuit 2410 is configured to, based on the trending value, transmit a recommendation message to the receiver circuit 2404 at the manufacturer 2402 identifying a modification to the product (that is being created by an existing product manufacturing process 2403) or the creation of a new product (that will be created by a new product manufacturing process 2405).

The existing product manufacturing process 2403 and the new product manufacturing process 2405 may, in aspects, include or utilize the same or different tools, assembly lines, or any other apparatus or machines that create or manufacture products. The existing product manufacturing process 2403 creates an existing product 2407 and the new product manufacturing process 2405 creates a new product 2409. By a “new” product, it is meant that the product was created (at some point in time) based upon a recommendation of the control circuit 2410. The existing product manufacturing process 2403 and the new product manufacturing process 2405 may, in other aspects, include or utilize services such as advertising and promotion services.

The modification of the product or the creation of the new product, when made by the manufacturer 2402, is effective to increase an alignment between the one or more vectorized product characterizations and the trending values. The increased alignment is effective to maximize customer purchases of the product or the new product.

In aspects, product modification of the existing product 2407 or creation of the new product 2409 are effective to adjust a strength of one of the vectorized product characterizations of the existing product 2407 or the new product 2409.

In other aspects, the trending value is the customer preference having the greatest change over a predetermined time period amongst the customer partiality vectors. In still other aspects, the trending value is the customer preference having the greatest strength amongst the customer partiality vectors.

In some examples, the recommendation message specifies an adjustment to the sourcing of parts of the product. In still other examples, the recommendation message specifies an adjustment to the advertising or marketing for the product. In yet other examples, the recommendation message specifies an adjustment be made to the physical characteristics of the product.

In some examples, the customer preference relates to a color, size, weight, source, price, or associated promotion associated with the product. In other examples, the product characteristic relates to a color, size, weight, source, price, or associated promotion associated with the product.

In some aspects, the control circuit 2410 is configured to select a subset of the customer partiality vectors. For example, partiality vectors of customers living in certain geographic areas, customers with certain income levels, or customers with certain educational levels can be selected. Other examples are possible.

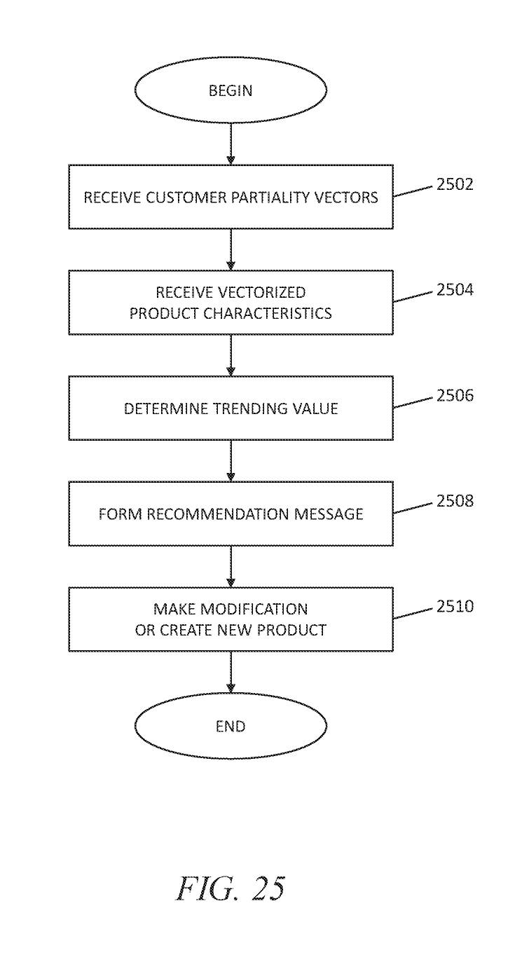

Referring now to FIG. 25, one example of increasing alignment of a manufacturer's or supplier's products to customer values is described. At step 2502, at a central processing center, a plurality of customer partiality vectors are received from a database. Each of the customer partiality vectors comprises a customer preference of a customer that is programmatically linked to a strength of the customer preference. The partiality vectors may be stored as any type of data structure. In one example, a customer partiality vector may relate to the price of a product. An integer value may represent the strength of the value or the angle of the vector may represent the strength.

At step 2504, at the central processing center, a plurality of vectorized product characterizations is received from the database. Each of the vectorized product characterizations comprises a product characteristic programmatically linked to a strength of the product characteristic. The vectorized product characterizations may be stored as any type of data structure. In one example, a vectorized product characterization may relate to the price of a product. An integer value may represent the strength of the value or the angle of the vectorized product characterization may represent the strength.

At step 2506 and based upon an analysis of strengths of the customer preferences for selected ones of the customer partiality vectors and at the central processing center, one or more trending values is determined. For example, the strengths of the customer partiality vectors may be summed, and divided by the number of customer partiality vectors. If the result exceeds a predetermined threshold, then the value may be determined to be a trending value.

At step 2508, at the central processing center and based on the trending value, a recommendation message is formed and transmitted to the receiver circuit identifying a product modification to a product or the creation of a new product. The product modification to an existing product or the creation of the new product, when made by the manufacturer, is effective to increase an alignment between at least one of the vectorized product characterizations and the trending values such that the increased alignment is effective to maximize customer purchases of the existing product.

Different approaches can be utilized to determine a particular recommendation. In one approach, if one trending value is determined, a look-up table may be used to obtain a predetermined recommendation. In still other approaches, other customer values may also be analyzed. For instance, if economical pricing were determined (from an analysis of the customer partiality vectors) to be an important or trending value (e.g., the average strength were above a predetermined threshold), then the recommendation may be modified to take these other customer values into account.

At step 2510, the modification to an existing product is made or the new product is created. The determination of whether to develop a new product or to modify an existing product may utilize factors such as the cost to modify (versus the cost to produce a new product), or the time to modify production of an existing product (versus the cost to produce a new product). Other examples are possible.

When modifying an existing product, the modification may include changing any type of product characteristic such as the size, dimensions, shape, texture, color, price, marketing strategy, sales strategy, sourcing or any other product attribute so as to align with the trending value(s). When a new product is created, the new product's characteristics (e.g., the size, dimensions, shape, texture, color, price, marketing strategy, sales strategy, sourcing or any other product attribute) are selected so as to align with the trending value(s).

When a product modification is made, this modification is effective to modify a strength of one of the vectorized product characterizations of the product. The modified strength increases an alignment between at least one of the vectorized product characterizations of the product and the trending values such that the increased alignment maximizes customer purchases of the product. When a new product is created, one or more of the vectorized product characterizations of the new product have a satisfactory alignment with the trending values such that the alignment is effective to maximize customer purchases of the new product.

In aspects, vector dot product calculations can serve to help identify whether the existing product or new product aligns with the trending values. Such an approach can be particularly useful when the lengths of the vectors are allowed to vary as a function of one or more parameters of interest. As those skilled in the art will understand, a vector dot product is an algebraic operation that takes two equal-length sequences of numbers (in this case, coordinate vectors) and returns a single number.

As mentioned above, this operation can be defined either algebraically or geometrically. Algebraically, it is the sum of the products of the corresponding entries of the two sequences of numbers. Geometrically, it is the product of the Euclidean magnitudes of the two vectors and the cosine of the angle between them. The result is a scalar rather than a vector. Accordingly, when using vector angles to impart this magnitude information, the vector dot product operation provides a simple and convenient way to determine proximity between a particular customer trending values and the performance/properties of a particular product to thereby greatly facilitate identifying a best product amongst a plurality of candidate products. When a customer perceives that the alignment is (to the customer) satisfactory, then the customer may purchase the product.

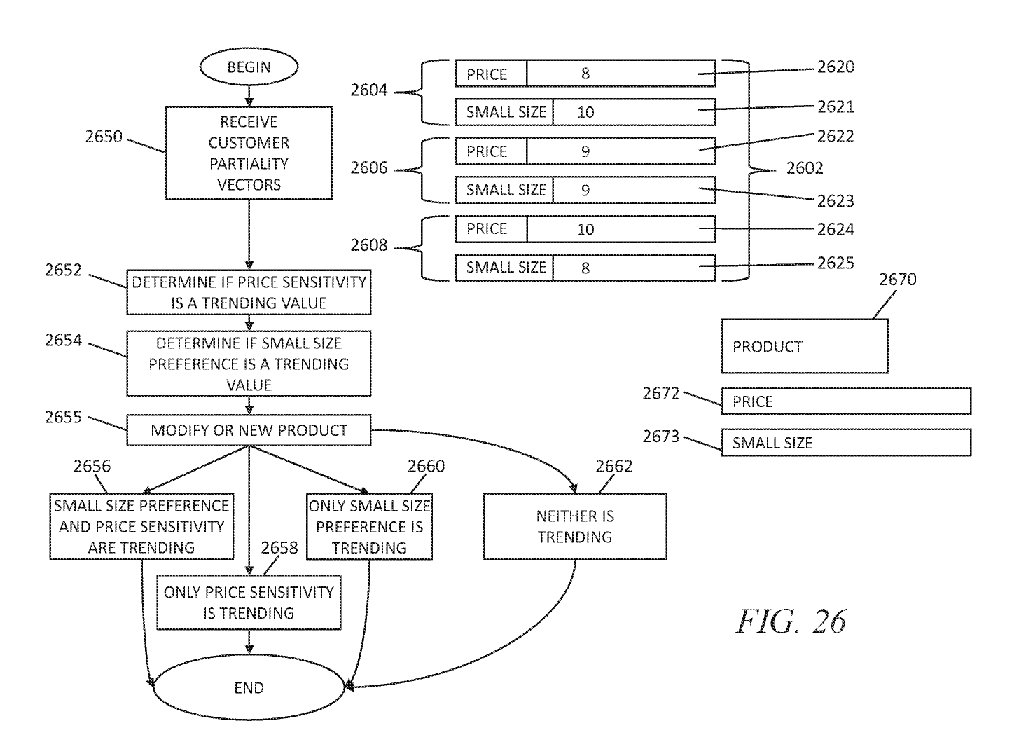

Referring now to FIG. 26, one example of an approach for optimizing customer purchases of a product 2670 produced by a manufacturer or supplier is described. In this example, the product is a vehicle such as a passenger automobile. It will be appreciated that the example of FIG. 26 is one example of a process whereby trending values are analyzed to determine an appropriate recommendation to send in a recommendation message to a manufacturer or supplier. Other examples are possible.

At step 2650, customer partiality vectors 2602 are received. In this example, groupings 2604, 2606, and 2608 are from or associated with three different customers. Grouping 2604 (including vectors 2620 and 2621) is from or associated with a first customer. Grouping 2606 (including vectors 2622 and 2623) is from or associated with a second customer. Grouping 2608 (including vectors 2624 and 2625) is from or associated with a third customer.

Each of the customer partiality vectors has a customer value (e.g., “price sensitivity” or “small size car preference”) and a strength (represented by an integer). Vectors 2620, 2622, and 2624 relate to the price sensitivity of a particular customer. Vectors 2621, 2623, and 2625 relate to the small size car preference of a particular customer. The angles may all be 0 degrees in this example. In other aspects, the angle may represent the strength and the vectors would all have the same strength or magnitude.

At steps 2652 (for small size car preference) and 2654 (for price sensitivity), it is determined whether the particular customer value is a trending value. In aspects, this is accomplished by analyzing the customer partiality vectors 2602.

With step 2652, customer partiality vectors 2621, 2623, and 2625 are examined and have strengths of 10, 9, and 8. The sum of strengths are added together, and then divided by the number of vectors to obtain an average. If the average is above a first predetermined threshold, then the small size car value is considered to be a trending value. In this example, the values are added together (10+9+8=27). The sum is divided by 3 (27/3=9). If the first threshold (relating to blue color preference) has been set to be 8, then small size car preference is determined to be a trending value because 9 is greater than 8. The first threshold can be adjusted by a user as needed or required.

A determination as to whether price sensitivity is a trending value is made at step 2054 with an examination of the vectors 2620, 2622, and 2624. In this case, the strengths of these vectors are 8, 9, and 10. The sum of strengths are added together, and then divided by the number of vectors to obtain an average. If the average is above a second predetermined threshold, then the value is considered to be a trending value. In this example, the strengths are added together (8+9+10=27), and then the sum is divided by 3 to obtain a result (27/3=9). If the second threshold (relating to price sensitivity) has been set to be 8, then price sensitivity is determined to be a trending value because 9 is greater than 8. If the second threshold (relating to price preference) has been set to be 8, then price preference is determined to be a trending value because 9 is greater than 8. The second threshold can be adjusted by a user as needed or required. The first threshold and the second threshold can be the same or different.

A recommendation message is then formed. Generally speaking, the recommendation message offers suggestions to the manufacturer or supplier that effectively increases an alignment between the trending value(s) and the value proposition (vectorized product characterizations) of selected products produced by the manufacturer or a new product created by the manufacturer.

At step 2655, it is determined whether the recommendation is whether to modify an existing product or to create a new product. Factors such as cost, profitability, and timing may be considered in making this determination. These factors may relate to both existing and proposed new products. It will be appreciated that in some cases both an existing product may be modified and a new product created.

For example, it may cost an additional $10 million to modify an existing car being produced (taking account of such factors as modifications to assembly line, re-design costs, changes to materials, and lost sales of existing models), versus $100 million to produce an entirely new car (taking into account such factures as constructing a new assembly line, hiring new workers, and design costs for the new car). This all may be balanced against the expected sales of the small car (and lost sales to larger cars if an existing product (e.g., large cars) is changed). The profitability of various products may also be considered.

Putting all this together, if 10 million people (as determined by their customer partiality vectors) indicate a strong preference for small cars, if producing the small cars would be profitable, and if there is already an existing strong customer base for large cars, then the choice may be to create a new vehicle rather than modify an existing vehicle.

In the example of FIG. 26, both values (small car preference and price sensitivity) are trending. At step 2655, it is determined whether a new vehicle should be produced or an existing one modified. Step 2656 is then executed. This step determines a recommendation that balances price and small car preference considerations. If step 2656 is reached, then the recommendation may be to produce a new product that is small vehicle, but to limit the price of the product 2670 to a specific amount. Other examples are possible.

If only price sensitivity is trending, then step 2658 is executed. In examples, the recommendation at step 2658 may be to lower the price of all vehicles to particular values (e.g., where the value is determined by customer surveys). Other examples are possible.

If only the small size vehicle preference is trending, then step 2660 is executed. In examples, the recommendation at step 2660 may be to change a vehicle to be small (or to produce a small vehicle) and then advertise this size to customers. Other examples are possible.

The product 2670 at the store has a first vectorized product characterization 2672 (relating to price) and a second vectorized product characterization 2673 (relating to the small size of the product). When the recommendations are followed, the result is to change the values and/or angles of the first vectorized product characterization 2672 and the second vectorized product characterization 2673 to better align with the trending values such that customer purchases of the product are maximized. The customers may be a retail store (or group of stores) or individual customers. Other examples are possible. In aspects, the strengths and/or directions of the first vectorized product characterization 2672 and the second vectorized product characterization 2673 are adjusted so as to be in closer alignment to the trending values.

In this example, step 2656 is executed since both price sensitivity and small size are trending values. The recommendation message formed at step 2656 offers a specific recommendation to construct a new product that is a small vehicle, but without over-pricing the item. In so doing, customer purchases of the vehicles are maximized.

As the customers' values change, the product choices, characteristics, pricing, and/or advertising will move in that direction. For example, pricing sensitivity may drop in importance while small size preference remains the same (or grows stronger) so that more expensive small vehicles can be produced. The manufacturer is constantly adjusting the alignment of the value proposition of its products against customer values (e.g., trending values) so as to provide the best chance a customer will purchase the product. Put another way, trending values change over time as some values become trending and other values are no longer trending.

In other aspects, a subset of the customer partiality vectors may be determined and only customer partiality vectors from these customers considered in determining trending values. For example, partiality vectors of customers living in certain geographic areas, customers with certain income levels, or customers with certain educational levels can be selected. Other examples are possible. The number of customers in the subset may be any integer 1 or greater.

By some approaches the above-described teachings can be fairly represented by one or more of the following characterizing statements.

In some embodiments, 1. A system for providing custom manufacturing, comprises: a communication device configured to communicate with a plurality of user devices and a plurality of manufacturer systems over a network; a customer database storing customer profiles associated with a plurality of customers; a manufacturer database storing manufacturer characteristics associated with a plurality of manufacturers; and a control circuit coupled to the communication device, the customer database, and the manufacturer database, the control circuit being configured to: provide a custom manufacturing user interface to the plurality of user devices; receive a custom manufacturing request from a user via the custom manufacturing user interface; retrieve a customer profile associated with the user from the customer database; determine alignments between the customer profile and the manufacturer characteristics associated with the plurality of manufacturers stored in the manufacturer database; select matching manufacturers from the plurality of manufacturers based on the alignments; forward the custom manufacturing request to manufacturer systems associated with the matching manufacturers for bidding; receive bids for the custom manufacturing request from the manufacturer systems; and fulfill the custom manufacturing request with a bid associated with a manufacturer selected from among the bids.

Various implementations of these embodiments can be expressed as follows. 2. The system of characterization 1, wherein the customer profile comprises customer value vectors, wherein the customer value vectors each represents at least one of a person's values leading to at least one of a plurality of possible preferences and affinities and comprises a magnitude that corresponds to the customer's belief in good that comes from an order associated with that value. 3. The system of characterization 1, wherein the control circuit is further configured to: select materials for completing the custom manufacturing request based on the customer profile. 4. The system of characterization 3, wherein the matching manufacturers are further selected based on the material selected for the custom manufacturing request. 5. The system of characterization 1, wherein the control circuit is further configured to: provide customer value vectors in the customer profile to the manufacturer. 6. The system of characterization 1, wherein the alignments comprise match scores for the plurality of manufacturers and the matching manufacturers are selected based on the match scores for each of the plurality of manufacturers. 7. The system of characterization 1, wherein the control circuit is further configured to: automatically select the bid from the bids received from the manufacturer systems to fulfill the custom manufacturing request based on prices associated with the bids. 8. The system of characterization 1, wherein the control circuit is further configured to: present the matching manufacturers to the user via the custom manufacturing user interface for user selection. 9. The system of characterization 1, wherein the matching manufacturers are further selected based on each manufacturer's ability to complete the custom manufacturing request. 10. The system of characterization 1, wherein the custom manufacturing request comprises one or more of a 3D printed object based on a photograph, a 3D printed object based on a 3D scan, a custom tailored article of clothing, a custom printed object, a food item, a furniture item, and a decorative item.

In some embodiments, 11. a method for providing custom manufacturing, comprises: providing, via a communication device configured to communicate with a plurality of user devices and a plurality of manufacturer systems over a network, a custom manufacturing user interface to the plurality of user devices; receiving, at a control circuit coupled to the communication device, a custom manufacturing request from a user via the custom manufacturing user interface; retrieving a customer profile associated with the user from a customer database storing customer profiles associated with a plurality of customers; determining alignments between the customer profile associated with the user and manufacturer characteristics associated with a plurality of manufacturers stored in a manufacturer database; selecting, with the control circuit, matching manufacturers from the plurality of manufacturers based on the alignments; forwarding the custom manufacturing request to manufacturer systems associated with the matching manufacturers for bidding; receiving, at the control circuit, bids for the custom manufacturing request from the manufacturer systems; and fulfilling the custom manufacturing request with a bid associated with a manufacturer selected from among the bids.

Various implementations of these embodiments can be expressed as follows. 12. The method of characterization 11, wherein the customer profile comprises customer value vectors, wherein the customer value vectors each represents at least one of a person's values leading to at least one of a plurality of possible preferences and affinities and comprises a magnitude that corresponds to the customer's belief in good that comes from an order associated with that value. 13. The method of characterization 11, further comprising: selecting materials for completing the custom manufacturing request based on the customer profile. 14. The method of characterization 13, wherein the matching manufacturers are further selected based on the material selected for the custom manufacturing request. 15. The method of characterization 11, further comprising: provide customer value vectors in the customer profile to the manufacturer. 16. The method of characterization 11, wherein the alignments comprise match scores for the plurality of manufacturers and the matching manufacturers are selected based on the match scores for each of the plurality of manufacturers. 17. The method of characterization 11, further comprising: automatically select the bid from the bids received from the manufacturer systems to fulfill the custom manufacturing request based on prices associated with the bids. 18. The method of characterization 11, wherein the matching manufacturers are further selected based on each manufacturer's ability to complete the custom manufacturing request. 19. The method of characterization 11, wherein the custom manufacturing request comprises one or more of a 3D printed object based on a photograph, a 3D printed object based on a 3D scan, a custom tailored article of clothing, a custom printed object, a food item, a furniture item, and a decorative item.

In some embodiments, 20. an apparatus for providing custom manufacturing, comprises: a non-transitory storage medium storing a set of computer readable instructions; and a control circuit configured to execute the set of computer readable instructions which causes to the control circuit to: provide, via a communication device configured to communicate with a plurality of user devices and a plurality of manufacturer systems over a network, a custom manufacturing user interface to the plurality of user devices; receive a custom manufacturing request from a user via the custom manufacturing user interface; retrieve a customer profile associated with the user from a customer database storing customer profiles associated with a plurality of customers; determine alignments between the customer profile associated with the user and manufacturer characteristics associated with a plurality of manufacturers stored in a manufacturer database; select matching manufacturers from the plurality of manufacturers based on the alignments; forward the custom manufacturing request to manufacturer systems associated with the matching manufacturers for bidding; receive bids for the custom manufacturing request from the manufacturer systems; and fulfill the custom manufacturing request with a bid associated with a manufacturer selected from among the bids.

By some further approaches the above-described teachings can be fairly represented by one or more of these characterizing statements. 1. A system that is configured to maximize certainty for customer purchases of a product from a manufacturer, the system comprises: a receiver circuit at a manufacturer; a communication network coupled to the receiver circuit; a database including a plurality of customer partiality vectors, wherein each of the customer partiality vectors comprises a customer preference that is programmatically linked to a strength of the customer preference, the database also including a plurality of vectorized product characterizations, wherein each of the vectorized product characterizations comprise a product characteristic associated with a product produced by the manufacturer that is programmatically linked to a strength of the product characteristic; a control circuit coupled to the database and the communication network, the control circuit being disposed at a central processing center, the control circuit configured to: based upon an analysis of strengths of the customer preferences for selected ones of the customer partiality vectors, determine one or more trending values; based on the trending value, transmit a recommendation message to the receiver circuit at the manufacturer identifying a modification to the product or the creation of a new product, the modification of the product or the creation of the new product, when made by the manufacturer, being effective to increase an alignment between the one or more vectorized product characterizations and the trending values; such that the increased alignment is effective to maximize customer purchases of the product or the new product.

Various implementations of these embodiments can be expressed as follows. 2. The system of characterization 1, wherein the at least one product modification is effective to adjust a strength of one of the vectorized product characterizations of the existing product. 3. The system of characterization 1, wherein the trending value is the customer preference having the greatest change over a predetermined time period amongst the customer partiality vectors. 4. The system of characterization 1, wherein the trending value is the customer preference having the greatest strength amongst the customer partiality vectors. 5. The system of characterization 1, wherein the recommendation message specifies an adjustment to the sourcing of parts of the product. 6. The system of characterization 1, wherein the recommendation message specifies an adjustment to the advertising or marketing for the product. 7. The system of characterization 1, wherein the recommendation message specifies an adjustment be made to the physical characteristics of the product. 8. The system of characterization 1, wherein the customer preference relates to a color, size, weight, source, price, or associated promotion associated with the product. 9. The system of characterization 1, wherein the product characteristic relates to a color, size, weight, source, price, or associated promotion associated with the product. 10. The system of characterization 1, wherein the control circuit is configured to select a subset of the customer partiality vectors.

In some embodiments, 11. a method for maximizing certainty for customer purchases of a product from a manufacturer, comprises: at a central processing center, receiving a plurality of customer partiality vectors from a database, wherein each of the customer partiality vectors comprises a customer preference of a customer that is programmatically linked to a strength of the customer preference; at the central processing center, receiving a plurality of vectorized product characterizations from the database, wherein each of the vectorized product characterizations comprises a product characteristic programmatically linked to a strength of the product characteristic; based upon an analysis of strengths of the customer preferences for selected ones of the customer partiality vectors and at the central processing center, determining one or more trending values; at the central processing center and based on the trending value, forming and transmitting a recommendation message to the receiver circuit identifying a product modification to a product or the creation of a new product, the product modification or the creation of the new product, when made by the manufacturer, being effective to increase an alignment between at least one of the vectorized product characterizations and the trending values such that the increased alignment is effective to maximize customer purchases of the existing product.

Various implementations of these embodiments can be expressed as follows. 12. The method of characterization 11, wherein the at least one product modification is effective to adjust a strength of one of the vectorized product characterizations of the existing product. 13. The method of characterization 11, wherein determining the trending value comprises selecting the customer preference having the greatest change over a predetermined time period from the customer partiality vectors. 14. The method of characterization 11, wherein determining the trending value comprises selecting the customer preference having the greatest strength the customer partiality vectors. 15. The method of characterization 11, wherein the recommendation message specifies an adjustment to the sourcing parts of the product. 16. The method of characterization 11, wherein the recommendation message advises adjusting the advertising or marketing for the product. 17. The method of characterization 11, wherein the recommendation message advises adjusting the physical characteristics of the product. 18. The method of characterization 11, wherein the customer preference relates to a color, size, weight, source, price, or associated promotion associated with the product. 19. The method of characterization 11, wherein the product characteristic relates to a color, size, weight, source, price, or associated promotion associated with the product. 20. The method of characterization 11, further comprising selecting a subset of the customer partiality vectors.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

This application is related to, and incorporates herein by reference in its entirety, each of the following U.S. provisional applications listed as follows by application number and filing date: 62/323,026 filed Apr. 15, 2016; 62/341,993 filed May 26, 2016; 62/348,444 filed Jun. 10, 2016; 62/350,312 filed Jun. 15, 2016; 62/350,315 filed Jun. 15, 2016; 62/351,467 filed Jun. 17, 2016; 62/351,463 filed Jun. 17, 2016; 62/352,858 filed Jun. 21, 2016; 62/356,387 filed Jun. 29, 2016; 62/356,374 filed Jun. 29, 2016; 62/356,439 filed Jun. 29, 2016; 62/356,375 filed Jun. 29, 2016; 62/358,287 filed Jul. 5, 2016; 62/360,356 filed Jul. 9, 2016; 62/360,629 filed Jul. 11, 2016; 62/365,047 filed Jul. 21, 2016; 62/367,299 filed Jul. 27, 2016; 62/370,853 filed Aug. 4, 2016; 62/370,848 filed Aug. 4, 2016; 62/377,298 filed Aug. 19, 2016; 62/377,113 filed Aug. 19, 2016; 62/380,036 filed Aug. 26, 2016; 62/381,793 filed Aug. 31, 2016; 62/395,053 filed Sep. 15, 2016; 62/397,455 filed Sep. 21, 2016; 62/400,302 filed Sep. 27, 2016; 62/402,068 filed Sep. 30, 2016; 62/402,164 filed Sep. 30, 2016; 62/402,195 filed Sep. 30, 2016; 62/402,651 filed Sep. 30, 2016; 62/402,692 filed Sep. 30, 2016; 62/402,711 filed Sep. 30, 2016; 62/406,487 filed Oct. 11, 2016; 62/408,736 filed Oct. 15, 2016; 62/409,008 filed Oct. 17, 2016; 62/410,155 filed Oct. 19, 2016; 62/413,312 filed Oct. 26, 2016; 62/413,304 filed Oct. 26, 2016; 62/413,487 filed Oct. 27, 2016; 62/422,837 filed Nov. 16, 2016; 62/423,906 filed Nov. 18, 2016; 62/424,661 filed Nov. 21, 2016; 62/427,478 filed Nov. 29, 2016; 62/436,842 filed Dec. 20, 2016; 62/436,885 filed Dec. 20, 2016; 62/436,791 filed Dec. 20, 2016; 62/439,526 filed Dec. 28, 2016; 62/442,631 filed Jan. 5, 2017; 62/445,552 filed Jan. 12, 2017; 62/463,103 filed Feb. 24, 2017; 62/465,932 filed Mar. 2, 2017; 62/467,546 filed Mar. 6, 2017; 62/467,968 filed Mar. 7, 2017; 62/467,999 filed Mar. 7, 2017; 62/471,804 filed Mar. 15, 2017; 62/471,830 filed Mar. 15, 2017; 62/479,525 filed Mar. 31, 2017; 62/480,733 filed Apr. 3, 2017; 62/482,863 filed Apr. 7, 2017; 62/482,855 filed Apr. 7, 2017; 62/485,045 filed Apr. 13, 2017; Ser. No. 15/487,760 filed Apr. 14, 2017; Ser. No. 15/487,538 filed Apr. 14, 2017; Ser. No. 15/487,775 filed Apr. 14, 2017; Ser. No. 15/488,107 filed Apr. 14, 2017; Ser. No. 15/488,015 filed Apr. 14, 2017; Ser. No. 15/487,728 filed Apr. 14, 2017; Ser. No. 15/487,882 filed Apr. 14, 2017; Ser. No. 15/487,826 filed Apr. 14, 2017; Ser. No. 15/487,792 filed Apr. 14, 2017; Ser. No. 15/488,004 filed Apr. 14, 2017; Ser. No. 15/487,894 filed Apr. 14, 2017; and 62/510,322, filed May 24, 2017.

What is claimed is:

1. A method comprising:
providing a plurality of base products;
accessing partiality vectors for people associated with each of a plurality of different geographic regions;
for each of the plurality of different geographic regions:
using the partiality vectors to identify a particular partiality vector that is representative of people associated with the geographic region;
using the particular partiality vector to identify a particular customization for the geographic region;
using the corresponding particular customization to particularly customize at least some of the plurality of base products such that at least some of the base products offered within the geographic region is customized in a way that corresponds to the particular partiality vector that is representative of people associated with the geographic region.

2. The method of claim 1 wherein the geographic regions comprise areas within a predetermined distance of a retail shopping facility operated by a same enterprise.

3. The method of claim 1 wherein the partiality vector represents at least one of a person's values, preferences, and affinities.

4. The method of claim 1 wherein the particular customization comprises adding additional product content to the base product to form a composite product.

5. The method of claim 4 wherein the additional product content comprises content that is locally sourced with respect to the corresponding geographic region.

6. The method of claim 1 wherein the particular customization comprises customized packaging for the base product.

7. The method of claim 1 further comprising:
for each of the plurality of different geographic regions:
calculate a number of people associated with the geographic region for whom the particular partiality vector is representative;
and wherein using the corresponding particular customization to particularly customize at least some of the plurality of base products comprises determining how many of the base products to so customize as a function of the number of people associated with the geographic region for whom the particular partiality vector is representative.

8. The method of claim 1 further comprising:
transporting a quantity of the base products to each of the plurality of different geographic regions.

9. The method of claim 8 wherein using the corresponding particular customization to particularly customize at least some of the plurality of base products comprises customizing the base products within the geographic region.

10. An apparatus comprising:
a plurality of retail shopping facilities, wherein each of the retail shopping facilities is located in a different geographic region;
a plurality of base products disposed at each of the plurality of retail shopping facilities;
a product customizer at each of the different geographic regions configured to customize at least some of the base products as a function of a particular partiality vector that is representative of people associated with the corresponding geographic region, such that the base products are available to customers at each of the different geographic regions in a customized form that accords with a regionally-specific partiality vector.

11. The apparatus of claim 10 wherein the partiality vector represents at least one of a person's values, preferences, and affinities.

12. The apparatus of claim 10 wherein the customization comprises adding additional product content to the base product to form a composite product.

13. The apparatus of claim 12 wherein the additional product content comprises content that is locally sourced with respect to the corresponding geographic region.

14. The apparatus of claim 10 wherein the customization comprises customized packaging for the base product.
